(19) United States
(12) Patent Application Publication
(10) Pub. No.: US 2023/0401039 A1
(43) Pub. Date: Dec. 14, 2023

(54) UNIVERSAL CODE EDITOR

(71) Applicant: Oracle International Corporation, Redwood Shores, CA (US)

(72) Inventors: Pankaj Mathur, Bothell, WA (US); Fahd Abidi, Danville, CA (US); Mingchi Stephen Mak, Redwood Shores, CA (US); Viral Divyesh Modi, San Jose, CA (US); William Drake Pijewski, Orinda, CA (US)

(73) Assignee: Oracle International Corporation, Redwood Shores, CA (US)

(21) Appl. No.: 18/206,524

(22) Filed: Jun. 6, 2023

Related U.S. Application Data
(60) Provisional application No. 63/351,676, filed on Jun. 13, 2022.

(51) Int. Cl. G06F 8/33

(52) U.S. Cl. CPC G06F 8/33

(57) ABSTRACT

A universal code editor (UCE) is described that can be used for authoring and editing artifacts associated with multiple different cloud services. A single instance of the UCE and the associated user interface (UI) can be used to select and edit one or more artifacts from different cloud services. The cloud services may be provided by the same cloud service provider or by different cloud service providers. In certain embodiments, the UCE is implemented as part of a cloud-based IDE.

### CROSS-REFERENCE TO RELATED APPLICATION

The present patent application claims priority to and is a non-provisional of U.S. Provisional Patent Application No. 63/351,676, titled “UNIVERSAL CODE EDITOR,” filed Jun. 13, 2022, the entire contents of which are incorporated by reference herein for all purposes.

### FIELD

The present disclosure relates generally to tools for editing artifacts, and more particularly, to a browser-based cloud code editor for editing artifacts associated with multiple cloud services.

### BACKGROUND

Software developers generally rely on tools such as Integrated Development Environments (IDEs) to write, edit, and debug software code. In the past, IDEs were installed on a developer's local machines and executed locally on the machines. More recently, IDEs have transitioned into the cloud space with several cloud IDEs being used by developers.

Currently, when it comes to editing code or artifacts related to cloud services, a separate IDE specifically tailored for that particular cloud service is needed for each cloud service. Thus, a first IDE is used for editing artifacts (e.g., code) related to a first cloud service and a second separate IDE is used for editing artifacts related to a second cloud service that is different from the first cloud service. Each cloud service team thus must provide their own code editor suited for that cloud service. A code editor that is used for editing artifacts for one cloud service cannot be used for editing artifacts for a different cloud service. This is the case even if the two cloud services are being provided by the same cloud service provider (CSP). This creates an enormous burden on the CSP since valuable human resources and time has to be spent in developing separate IDEs for the different services offered by the CSP.

### BRIEF SUMMARY

The present disclosure relates to IDEs and code editors, and more particularly, to an artifacts or code editor that facilitates the authoring and editing of artifacts from multiple different cloud services provided by one or more cloud service providers (CSPs). Various embodiments are described herein, including methods, systems, non-transitory computer-readable storage media storing programs, code, or instructions executable by one or more processors, and the like.

A universal code editor (UCE) is described that can be used for authoring and editing artifacts associated with multiple different cloud services. A single instance of the UCE and the associated user interface (UI) can be used to select and edit one or more artifacts from different cloud services. The cloud services may be provided by the same cloud service provider or by different cloud service providers. In certain embodiments, the UCE is implemented as part of a cloud-based IDE.

In certain implementations, a user (e.g., a developer) may invoke the UCE using a user device. Invocation of the UCE may cause an instance of the UCE to be invoked in a cloud environment. A graphical user interface (UI or GUI) provided by the UCE is displayed on the user device. In a browser-based implementation, the UI may be displayed as a window of a browser executed by the user device. The UCE UI may display a list of cloud services for selection by the user. The user can then, via the UI, select a particular cloud service. In response, the UCE connects to the appropriate code store or repository for the selected cloud service and retrieves or receives information related to a set of artifacts for that particular cloud service. Information identifying the artifacts is then displayed via the UCE UI on the user device. The user can then, via the UCE UI and interactions with the user device, select a particular artifact for editing. In response, an edit window is opened in the UI and the contents of the selected artifact are displayed in the edit window. The user can then edit the contents of the selected artifact via the edit. For example, the UCE UI may display a page (e.g., a tab) that displays the contents of the selected particular artifact. The user can then edit the contents (e.g., code) of that selected artifact. After the user has completed the edits, the user can select a user-selectable “Save/Store” operation provided by the UCE UI and, in response, the UCE causes the edited contents of the artifact to be stored to the artifacts/code repository corresponding to the particular cloud service.

The UCE thus enables a user to select a particular service from among multiple cloud services. The UCE then connects to the appropriate code store or repository for the selected cloud service. Artifacts associated with the selected service are displayed to the user and the user can then edit one or more of the artifacts. The edited artifacts are then stored back to the particular repository of the selected cloud service. In this manner, multiple cloud services may be selected and artifacts associated with those services may be edited using the same instance of the UCE and its associated UI.

In certain embodiments, a user interface (UI) associated with a code editor displays a plurality of cloud services, the plurality of cloud services including a first cloud service and a second cloud service. The code editor receives a first signal indicating selection, via the UI, of a first cloud service from the plurality of cloud services. A first edit area is displayed in the UI, the first edit area displaying contents of a first artifact associated with the first cloud service and enabling editing of the contents of the first artifact. The code editor receives a second signal indicating selection, via the UI, of a second cloud service from the plurality of cloud services, wherein the second cloud service is different from the first cloud service. A second edit area is displayed in the UI, the second edit area displaying contents of a second artifact associated with the second cloud service and enabling editing of the contents of the second artifact.

Examples of artifacts include a file containing code, a script file, a configuration information file, etc. An artifact may be used for enabling, provisioning, or deploying a cloud service.

The cloud services for which artifacts are displayed via the code editor may be provided by the same cloud service provider or the cloud services may be provided by different cloud service providers.

In certain embodiments, the UI may be displayed via a browser executing on a user device. In certain implementations, the code editor may also be executed on the user device. In other implementations, the user device may be separate and remote from a system that executed the code editor. In such an embodiment, the user device may be communicatively coupled with the system executing or hosting the code editor via a communication network.

In certain embodiments, responsive to receiving the first signal, the code editor establishes a connection with a first infrastructure associated with the first cloud service. The code editor obtains information related to a first set of one or more artifacts associated with the first cloud service, the first set of one or more artifacts including the first artifact. Information identifying the first set of one or more artifacts is then displayed by the code editor on the UI.

In certain implementations, the code editor receives a third signal indicating selection, via the UI, of the first artifact from the first set of one or more artifacts. The code editor obtains the first artifact from the first infrastructure associated with the first cloud service and displays the contents of the first artifact in the first edit area.

The code editor may receive, via the first edit area, one or more edits to the first artifact to generate edited contents for the first artifact. The code editor may receive a signal to save the edited contents of the first artifact. In response to receiving the signal to save the edited contents of the first artifact, the code editor may cause the edited contents of the first artifact to be stored in a repository associated with the first cloud service.

In certain implementations, responsive to receiving the second signal, the code editor establishes a connection with a second infrastructure associated with the second cloud service. The code editor obtains information related to a second set of one or more artifacts associated with the second cloud service, the second set of one or more artifacts including the second artifact. The code editor displays on the UI information identifying the second set of one or more artifacts. The code editor may receive a fourth signal indicating selection, via the UI, of the second artifact from the second set of one or more artifacts. The code editor then obtains the second artifact from the second infrastructure associated with the second cloud service and displays the contents of the second artifact in the second edit area.

Various different techniques may be used to establish a connection between the code editor and the first infrastructure associated with the first cloud service. In certain implementations, plugins specific to the cloud services are used to facilitate these connections. For example, the code editor may use a first plugin for the first cloud service to connect to the first infrastructure for the first cloud service. The code editor may use a second plugin corresponding to the second cloud service to connect to the second infrastructure for the first cloud service. In this manner, by using plugins, the architecture of the code editor is extensible to support multiple different cloud services from one or more cloud service providers.

In certain implementations, the code editor may be part of an integrated development environment (IDE) such as a cloud IDE. The IDE may provide various tools and capabilities for authoring artifacts, editing artifacts, compiling artifacts, debugging artifacts, deploying artifacts, and the like. For example, the IDE may include a file explorer, a debugger, a compiler, a source control component, and other components.

Various different techniques may be used to display the contents of various artifacts belonging to one or different cloud services. For example, in certain implementations, multiple edit areas may be displayed simultaneously, where each edit area displays the contents of a particular artifact being edited in that edit area. In certain implementations, a foreground/background technique may be used to display the edit areas. At any time, one of the edit areas is active or in the foreground and the other edit areas are inactive or in the background. Contents in the foreground edit area are displayed to the user and are editable by the user. When the user clicks on a background edit area, the clicked upon edit area is made the active/foreground edit area and the contents displayed in that edit area are now displayed and are user editable, and the previous active/foreground edit area becomes the background area.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

The specification refers to the following figures.

FIG. 1 is a simplified block diagram of a distributed environment incorporating a universal code editor (UCE) according to certain embodiments.

FIGS. 2A and 2B depict a simplified flowchart depicting processing performed by a UCE while enabling editing of artifacts from one or more cloud services according to certain embodiments.

FIGS. 3A-3F show examples of illustrative UCE UIs (e.g., graphical user interfaces GUIs) that may be associated with a UCE according to certain embodiments.

FIG. 4 depicts a simplified high level flowchart depicting processing performed by a UCE according to certain embodiments.

FIG. 5 is a block diagram illustrating one pattern for implementing a cloud infrastructure as a cloud service system, according to at least one embodiment.

FIG. 6 is a block diagram illustrating another pattern for implementing a cloud infrastructure as a cloud service system, according to at least one embodiment.

FIG. 7 is a block diagram illustrating another pattern for implementing a cloud infrastructure as a cloud service system, according to at least one embodiment.

FIG. 8 is a block diagram illustrating another pattern for implementing a cloud infrastructure as a cloud service system, according to at least one embodiment.

FIG. 9 is a block diagram illustrating an example computer system, according to at least one embodiment.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

The present disclosure relates to IDEs and code editors, and more particularly, to an artifacts or code editor that facilitates the authoring and editing of artifacts from multiple different cloud services provided by one or more cloud service providers (CSPs). The code editor may be referred to as a “universal” code editor since it enables artifacts (e.g., code files) from different cloud services to be authored and edited using the same instance of the code editor. Thus, a universal code editor (UCE) is provided that enables a user to, via the same UCE instance, author and edit artifacts related to one or more cloud services.

An artifact for a cloud service is any editable content (e.g., an editable file) that is associated with the cloud service and used for enabling, provisioning, or deploying the cloud service. Examples of an artifact for a cloud service include a file containing code, a script file, a configuration information file, an editable file comprising machine-executable instructions, and other content associated with the service. Some of the artifacts for a cloud service may explain how the cloud service works and describe the software or code that enables the cloud services. An artifact for a cloud service may describe a software architecture, design, and functionality of the cloud service. A user may edit existing artifacts or create new artifacts for one or more cloud services using the UCE. In certain implementations, the UCE is implemented as a browser-based cloud code editor.

The artifacts associated with one cloud service may be different from the artifacts associated with a different cloud service. The differences may be in the type of artifacts, the number of artifacts, and also the contents of the artifacts. The artifacts for a cloud service may be stored in one or more repositories (e.g., databases, directories). The repositories and the organization used for storing artifacts for one cloud service may be the different from, same as, of partially different from the repositories and the organization used for storing artifacts for another different cloud services. The different cloud services may be provided by the same CSP or by different CSPs.

Although the term “code editor” has been used in this disclosure, this is not intended to limit the scope of the editor. The code editor as described herein can be used to edit any artifact associated with a cloud service. The editor described in this disclosure can thus be referred to as a code editor or an artifacts editor.

A cloud service as described herein can include any service delivered on demand by a CSP to a subscribing customer over a network such as over the Internet or an intranet using infrastructure provided by the CSP. By way of example, a cloud service can be of different types including Infrastructure-as-a-Service (IaaS), Platform-as-a-Service (PaaS), Software-as-a-Service (SaaS), Database-as-a-Service (DBaaS) and other type of cloud service type. The CSP provides the infrastructure (e.g., compute, networking, storage resources) that is used to provide a cloud service. A customer subscribing to a cloud service can use the cloud service without having to procure the infrastructure that is needed for providing the cloud service.

As alluded to in the Background section, there are several technical problems with existing code editors. Software development involves writing, editing, and managing code. Tools such as Integrated Development Environments (IDEs) are used by software developers, software editors, and software maintainers to write, edit, debug, and manage software code. An IDE provides a programming environment and typically includes a code or artifacts editor, a compiler, a debugger, a graphical user interface (GUI) builder, and other systems that are used by software developers for building a product or a service.

In the past, an IDE was installed on a developer's local machine and executed locally on the machine. Local IDEs have several limitations though. They are limited by the computing and storage power of the local machine they are installed on. This poses a challenge when users need to run heavier workloads or compile large pieces of code. It also makes it difficult to simulate the actual production environment, on which the code will finally run. Local IDEs also have to be setup with the correct configuration, packages, and libraries before they can be used. This is a non-trivial task that can take several hours and has to be performed by every single developer on their local machine. Using a local IDE makes pair programming and collaboration difficult. There can be differences in the local IDE environments of different members of a software development team, which can cause problems with triaging and finding solutions to software bugs as code that is working correctly on one team member's machine might not work or work differently on another's machine.

Cloud IDEs were developed to mitigate some of the problems posed by local IDEs. As with a local IDE, a cloud IDE has several components, such as a file explorer, code editor, debugger, a compiler, a source control component, and other components. A big advantage of a cloud-based IDE is that it can be accessed from anywhere, from any compatible device, via remote access. A cloud IDE is typically accessed via a browser executing on a user's device. This enables better collaboration among geographically dispersed developers. The setup time is also reduced and has to be done only once and is applicable to multiple users. However, cloud IDEs also have several limitations. One limitation is that, presently, each cloud service has to have its own specific cloud IDE. A cloud IDE associated with one cloud service cannot be used for another different cloud service. This is because components of a cloud IDE built for a particular cloud service are configured with libraries and packages that are specific to that cloud service and not compatible with other cloud services. This is the case even if the same cloud service provider (CSP) is providing the cloud services. This creates an enormous burden on the CSP since valuable human resources and time has to be spent in developing separate IDEs for the different services offered by the CSP.

The present disclosure describes a universal code editor (UCE) that can be used for authoring and editing artifacts associated with multiple different cloud services. A single instance of the UCE can be used to select and edit one or more artifacts from different cloud services. The cloud services may be provided by the same cloud service provider or by different cloud service providers. In certain embodiments, the UCE is implemented as part of a cloud-based IDE.

In certain implementations, a user (e.g., a developer) may invoke the UCE using a device used by the user (referred to herein as a user device). Invocation of the UCE may cause an instance of the UCE to be invoked in a cloud environment. A graphical user interface (UI or GUI) provided by the UCE is displayed on the user device. In a browser-based implementation, the UI may be displayed as a window of a browser executed by the user device. The UCE UI may display a list of cloud services for selection by the user. The user can then, via the UI, select a particular cloud service. In response, the UCE connects to the appropriate code store or repository for the selected cloud service and retrieves or receives information related to a set of artifacts for that particular cloud service. Information identifying the artifacts is then displayed via the UCE UI on the user device. The user can then, via the UCE UI and interactions with the user device, select a particular artifact for editing. In response, an edit window is opened in the UI and the contents of the selected artifact are displayed in the edit window. The user can then edit the contents of the selected artifact via the edit. For example, the UCE UI may display a page (e.g., a tab) that displays the contents of the selected particular artifact. The user can then edit the contents (e.g., code) of that selected artifact. After the user has completed the edits, the user can select a user-selectable “Save/Store” operation provided by the UCE UI and, in response, the UCE causes the edited contents of the artifact to be stored to the artifacts/code repository corresponding to the particular cloud service.

The UCE thus enables a user to select a particular service from among multiple cloud services. The UCE then connects to the appropriate code store or repository for the selected cloud service. Artifacts associated with the selected service are displayed to the user and the user can then edit one or more of the artifacts. The edited artifacts are then stored back to the particular repository of the selected cloud service. In this manner, multiple cloud services may be selected and artifacts associated with those services may be edited using the same instance of the UCE and its associated UI. This functionality is not possible with existing code editors with respect to cloud services.

In certain embodiments, the UCE enables multiple edit windows to be invoked and displayed in the UCE UI. The multiple edit windows may be invoked responsive to user interactions and displayed via the UCE UI for editing multiple artifacts from the same cloud service or for editing artifacts from multiple different cloud services. For example, while the contents of a selected artifact from one cloud service are being edited via the UCE UI, the user may select a second cloud service from the list of cloud services displayed by the UCE UI. In response, the same UCE instance connects to the appropriate code store or repository for the selected second cloud service and retrieves or receives information related to a set of artifacts for the second cloud service. Information identifying the artifacts from the second cloud service is then displayed via the UCE UI. The user can then, via the UCE UI, select a particular artifact from the second cloud service for editing. In response, a new second edit window is opened in the UI and the contents of the selected artifact from the second cloud service are displayed in the new edit window, where the user can edit the user contents. In this manner, multiple edit windows displaying artifacts belonging to different cloud services can be displayed by the UCE UI, thus enabling the user to edit the artifacts using the same UCE UI. After the user has completed the edits in the second edit window, the user can select a user-selectable “Save/Store” operation provided by the UI and, in response, the UCE causes the edited contents of the artifact of the second cloud service to be stored to the artifacts/code repository corresponding to the second cloud service.

The UCE enables multiple artifacts to be edited in parallel. An edit window is opened within the UCE UI for each artifact being edited and the contents of the artifacts are displayed in that window where the contents can be edited. These multiple artifacts being edited can be from the same cloud service or from different cloud services.

By enabling authoring and editing of artifacts associated with different cloud services, the UCE provides a consistent in-console code editing experience for multiple and potentially all cloud services provided by a CSP. This allows users (e.g., developers) to complete their workflows quickly without the need to context switch between console and local development environments.

The UCE thus provides a single tool that enables artifacts from different cloud services to be edited using the same instance of the UCE and via a common UI. The UCE instance is able to connect to and communicate with infrastructures and artifact/code repositories of different cloud services, retrieve artifacts information from the repositories, and enable those artifacts to be edited via the same UCE instance. The UCE instance thus provides a common tool for connecting to code bases of different cloud services and the ability, via a common interface, to edit artifacts (e.g., code files) related to the cloud services. This provides a user of the UCE an efficient way of editing code across cloud services using a common code editor. The user no longer has to invoke cloud service-specific code editors. This also makes code editing more efficient for users, as users may become familiar with the common UI, instead of having to learn how to navigate UIs specific to individual cloud services.

A user may also author/create new artifacts for one or more cloud services via the UCE UI. In certain implementations, for a particular cloud service, templates may be provided that guide the user for creation of the new artifacts for that cloud service. The user may create new artifacts with or without using such templates. The user may save the new artifacts to a cloud service repository associated with the cloud service. Other users with access to the cloud service repository may access and edit the new artifact as well.

In certain implementations, the UCE is accessed via a browser and the UCE UI is displayed via the browser. A browser-based front-end user interface for the UCE communicates with a back-end component that provides the functionality for the UCE. The back-end component may be implemented in the cloud using one or more infrastructure resources (e.g., compute, storage, and networking resources) provided by a CSP. The back-end component may be implemented using a compute instance, such as a virtual machine, container, etc. When the UCE is invoked by a user, a browser session is opened for the UCE and displayed via a browser executing on the user's device and one or more artifacts corresponding to one or more cloud services may then be edited using this browser session.

In addition to enabling editing of artifacts, the UCE also provides options for performing other operations (e.g., tasks or functions) with respect to an artifact being edited. These operations may be displayed in the UCE UI as user-selectable options. These operations may include various operations typically provided by a code editor. In certain implementations, the UCE may be part of an IDE, such as a cloud IDE, and provide functions that are provided by a cloud IDE. The IDE may provide various tools and capabilities for authoring artifacts, editing artifacts, compiling artifacts, debugging artifacts, deploying artifacts, managing artifacts, and the like. For example, for an artifact associated with a cloud service, the user can, via the UCE UI: (a) elect to save the edits, which causes the edits to be stored to a repository for that artifact; (b) debug the code in the artifact; (c) compile the artifact, (d) build an executable (or other object) using the artifact, (e) execute an executable or object built using an artifact, (f) deploy an artifact to a deployment target environment, and the like. For example, the IDE may include a file explorer, a debugger, a compiler, a source control component, and other components.

The ability to edit and create new artifacts from multiple cloud services enables a user to share contents between different artifacts. For example, if a user is making a change to an artifact corresponding to a particular cloud service and desires to replicate the change to one or more artifacts associated with different cloud services, the UCE UI now easily enables this. The user can select and open multiple edits windows via the UCE for displaying the artifact corresponding to the particular cloud service open along with artifacts of other cloud services where the change is to be replicated. The user can copy a code snippet to be replicated from the edit windows displaying contents of the particular cloud service artifact and insert the copied snippet into the artifacts of the other cloud services displayed in the other edit windows. This is all enabled from within the same UCE instance UI. This enables code to be easily shared between the different artifacts and enables debugging errors in parallel across code bases associated with different cloud services.

The UCE also enables a user to make “complementary” changes more conveniently across artifacts from different cloud services. Complementary changes are changes where a change to an artifact in one cloud service triggers a change to an artifact in a different second cloud service. This usually occurs when the first cloud service and the second cloud service interact with each other as part of a process flow. Since both the artifacts can now be simultaneously opened via the UI of the same UCE instance, the complementary changes can be made in parallel, and also be tested together. This is not possible with existing IDEs.

In certain implementations, the UCE is architected using an extensible plugin architecture. The UCE is architected to accept and use plugins for the various cloud services that the UCE supports. The UCE uses these plugins to communicate with the corresponding infrastructures/repositories of the corresponding cloud services. A plugin architecture enables the capabilities of the UCE to be extended to provide support for new cloud services. For example, a new cloud service can be easily integrated with the UCE by providing a plugin specific to the new cloud service. For example, for a new cloud service to be integrated into the UCE, a plugin for the new cloud service can be registered with the UCE, which then uses the plugin to communicate with the infrastructure for the new cloud service. The plugin “plugs into” the UCE, and via the plugin, the UCE can connect to and communicate with a code base or registry for the new cloud service. In this manner, new cloud services can be easily brought under the umbrella of the UCE.

The UCE can also be customized for individual end users. For example, the UCE may be customized to connect to and communicate with a user-specific storage location, such as, for example, a user's home directory. The UCE can also be customized to invoke user-desired editors for editing the artifacts. The editors themselves may be customized per the user's needs, such as, the look-and-feel of the editors, how artifacts contents are displayed (e.g., colors used, indentation, etc.) for editing, and the like. Customizations can also be made specific to particular cloud services. In certain implementations, default templates can be provided by the UCE for editing the artifacts and are usable across multiple cloud services, for example, providing a template for editing the code corresponding to the different cloud services. These templates can then be customized by a user per the user's needs.

The UCE UI can also be provided in different forms. In certain implementations, the UCE UI comprises multiple regions or areas, including: (a) a cloud services area; (b) an artifacts information area; (c) a tasks menu area; (d) one or more artifact edit areas for editing artifact contents; and (e) other areas.

In certain implementations, the cloud services area of the UCE UI is used for displaying information identifying a list of cloud services whose artifacts can be edited using the UCE. This list identifies cloud services that are supported by the UCE. For example, in a plugin architecture embodiment, this list may correspond to cloud services whose plugins are accessible to the UCE. These cloud services may be provided by the same CSP or may be provided by different CSPs. The cloud services area also allows the user to select a particular cloud service from the list of cloud services. In certain implementations, when the user selects a particular cloud service, information identifying the selected cloud service is communicated from the browser displaying the UCE UI to the UCE instance that may be executing in the cloud. When the UCE instance receives a signal from the user device indicating selection by the user of a particular cloud service from the cloud services area, the UCE may use a plugin corresponding to the selected cloud service to connect to infrastructure that provides the particular cloud service. For example, the UCE may use the service-specific plugin to connect to and communicate with cloud service infrastructure associated with the particular selected cloud service.

The UCE may then, via the plugin, receive information regarding a set of artifacts corresponding to the particular cloud service. The UCE may then communicate this information identifying the set of artifacts to the user device and the list of artifacts may then be displayed in the artifacts information area of the UCE UI. The artifacts information area allows the user to select a particular artifact to be edited. Upon receiving a signal from the user device indicating selection by the user of a particular artifact from the artifacts information area, the UCE may then retrieve the selected artifact from a repository of the selected cloud service and then cause an artifact edit area to be displayed by the UCE UI. The contents of the selected artifact are displayed in the artifact edit area and are editable by the user.

The user can then make changes to the artifact contents in the artifact edit area. Multiple artifact edit areas may be displayed corresponding to multiple artifacts being edited. In certain implementations, for example, in a browser-based implementation of the UI, multiple tabs may be displayed corresponding to the multiple artifact edit areas, with each tab corresponding to an edit area for a particular artifact being edited. For example, a first tab may display contents of a first artifact associated with a first cloud service, a second tab may display contents of a second artifact associated with the first cloud service, a third tab may display contents of an artifact associated with a second cloud service, a fourth tab may display contents of an artifact associated with a third cloud service, and so on.

In certain implementations, at any time, one of the tabs is the active or foreground tab and the other tabs are the inactive or background tabs. Contents in the foreground tab are displayed to the user and are editable by the user. The background tabs are individually selectable by the user via the UI. When the user clicks on a background tab, the clicked upon tab and the corresponding edit area is made the active/foreground tab and the contents displayed in that edit area are now displayed and are user editable, and the previous active/foreground edit area becomes the background area. In this manner, the user can switch between tabs corresponding to the different artifacts being edited in the same UCE instance, where the tabs can be displaying artifacts from different cloud services.

In certain implementations, more than one artifacts edit areas or tabs can be active/in the foreground at the same time. Depending upon the real estate available for displaying the UCE UI, two or more tabs may be displayed as active as the same time. For example, the multiple active tabs may be displayed next to each other.

The tasks menu area of the UI displays tasks or operations that can be performed on or with respect to the various artifacts that are displayed in the UCE UI or the various cloud services supported by the UCE. For example, the tasks menu may display operations that may be performed on one or more selected artifacts, or on a selected cloud service, and the like.

The UCE, as described herein, provides several different features that are not provided by existing IDEs. For example, the features include:

(1) A browser-based code editor that displays information regarding multiple cloud services to a user and enables the user to select a particular cloud service whose artifact is to be edited. The UCE provides the user the ability to select from multiple cloud services via a common browser UI.

(2) Upon selecting a cloud service, the UCE connects to the appropriate artifacts/code store for the selected cloud service, retrieves information about artifacts corresponding to the cloud service, and displays information identifying the artifacts to the user via the UCE UI. The user can then select a particular artifact and contents of the selected artifact are then output to the user via the UCE UI in a manner where the user can make edits to the contents.

(3) Via the same UCE UI communicatively coupled with a back-end UCE instance, multiple artifacts corresponding to a cloud service can be edited in parallel. Via the same UCE instance, multiple artifacts corresponding to different cloud services can be edited in parallel.

(4) The user can switch between tabs corresponding to the different artifacts being edited in the same UCE instance to select a particular artifact to be edited.

(5) The UCE enables data to be shared between the artifacts being edited corresponding to one or more cloud services. This shared data can include metadata and other types of data.

(6) The UCE provides a plugin architecture that enables additional cloud services to be easily supported or integrated into the UCE via plugins specific to those cloud services.

(7) The UCE enables functions to be shared and invoked for the different artifacts being edited corresponding to one or more cloud services.

(8) A user may make user-specific customizations to the UCE.

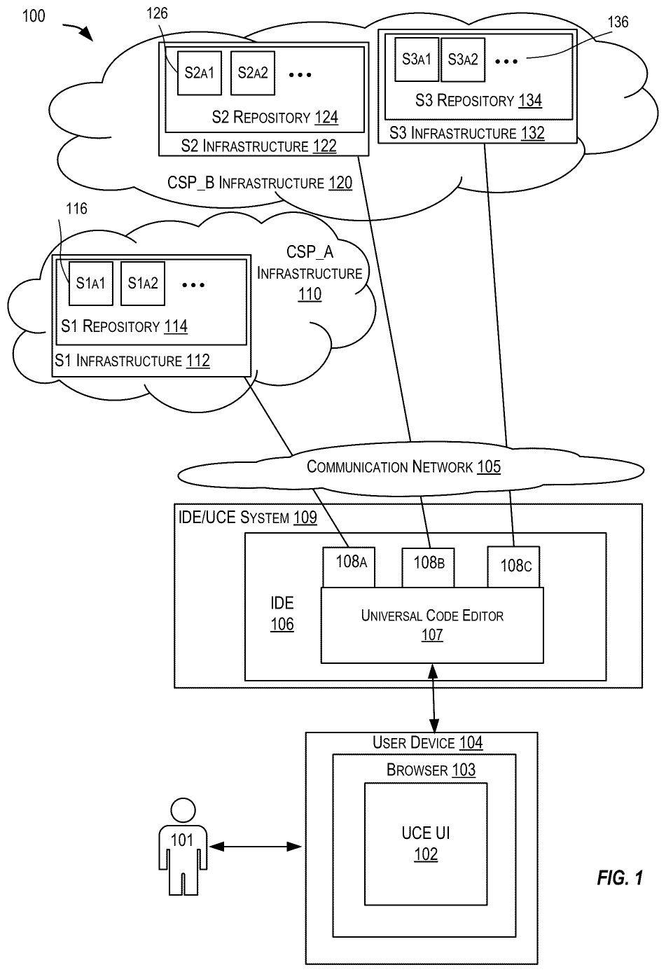

FIG. 1 is a simplified block diagram of a distributed environment 100 incorporating a universal code editor (UCE) according to certain embodiments. Distributed environment 100 may comprise multiple systems communicatively coupled to each other via one or more communication networks 105. The systems in FIG. 1 include a user device 104, an Integrated Development Environments (IDE)/UCE system 109, infrastructure 110 provided by a first CSP for providing one or more cloud services, and infrastructure 120 provided by a second CSP for providing one or more cloud services. Distributed environment 100 depicted in FIG. 1 is merely an example and is not intended to unduly limit the scope of claimed embodiments. Many variations, alternatives, and modifications are possible. For example, in some implementations, distributed environment 100 may have more or fewer systems or components than those shown in FIG. 1, may combine two or more systems, or may have a different configuration or arrangement of systems. The systems, subsystems, and other components depicted in FIG. 1 may be implemented in software (e.g., code, instructions, program) executed by one or more processing units (e.g., processors, cores) of the respective systems, using hardware, or combinations thereof. The software may be stored on a non-transitory storage medium (e.g., on a memory device).

Communication network 105 facilitates communications between the various systems depicted in FIG. 1. Communication network 105 can be of various types and can include one or more communication networks. Examples of communication network 105 include, without restriction, the Internet, a wide area network (WAN), a local area network (LAN), an Ethernet network, a public or private network, a wired network, a wireless network, and the like, and combinations thereof. Different communication protocols may be used to facilitate the communications including both wired and wireless protocols such as IEEE 802.XX suite of protocols, TCP/IP, IPX, SAN, AppleTalk®, Bluetooth®, and other protocols. In general, communication network 105 may include any infrastructure that facilitates communications between the various systems depicted in FIG. 1.

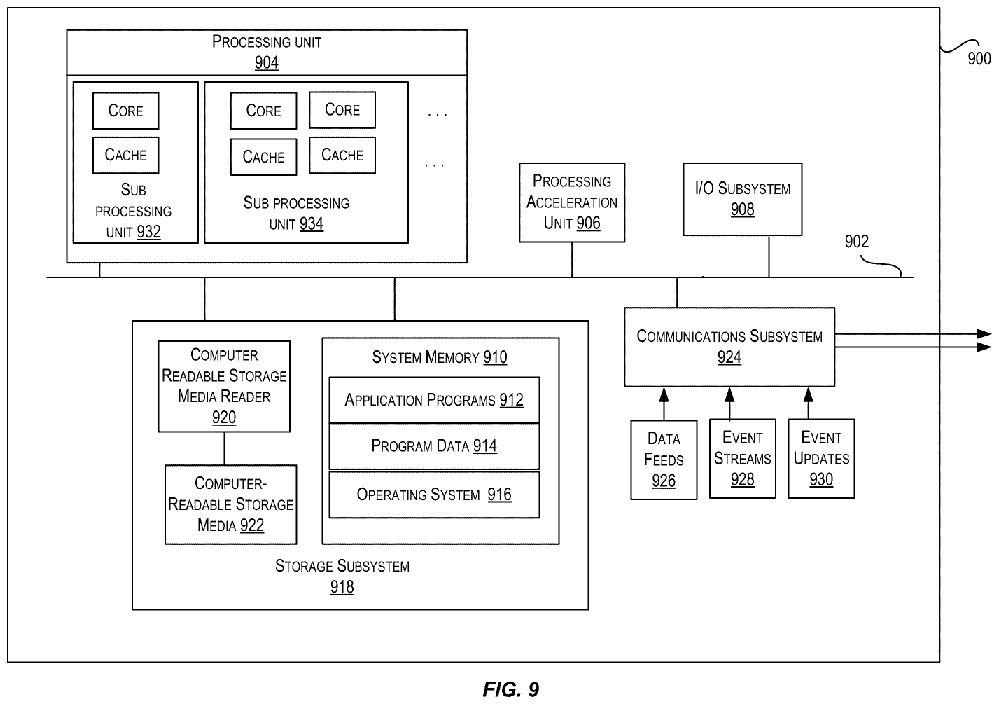

A user 101 may use user device 104 to interact with a UCE with functionality as described in this disclosure. For example, the user may, via user device 104, initiate a request to invoke the UCE. In response, a UCE 107 instance may be instantiated and a corresponding UCE UI 102 may be displayed on the user device 104. In the embodiment depicted in FIG. 1, the UCE 107 instance is instantiated on and executed by an IDE/UCE system 109. In some other implementations, UCE 107 instance may be instantiated on user device 104 itself. In certain implementations, IDE/UCE system 109 may be part of infrastructure provided by a CSP for providing one or more cloud services. For example, in IDE/UCE system, 109 may be provided as part of infrastructure 110 provided by cloud services provider CSP_A, or may be provided as part of infrastructure 120 provided by cloud services provider CSP_B. System 109 may comprise one or more computer systems, such as one or more of computer system 900 depicted in FIG. 9. System 109 may include one or more processing units or processors configured to execute computer-readable or machine-readable instructions. These computer-readable or machine-readable instructions may be stored on a non-transitory computer-readable medium.

User device 104 may be any computer system or device usable by user 101 such as a mobile device, a laptop, a desktop, and the like. User device 104 include an output subsystem (e.g., a screen, a monitor) that is capable of displaying UI and browser 103. User device 104 may also include an input subsystem (e.g., a mouse, a touch screen) that enables user 101 to interact with UCE UI 102 and browser 103.

In the embodiment depicted in FIG. 1, UCE 107 is a part of IDE 106. IDE 106 may be a cloud IDE. When invoked, an IDE 106 instance may be instantiated and a UCE 107 instance is part of the IDE instance. IDE 106 and UCE 107 may provide a set of development tools, libraries, and functionalities such as a compiler, debugger, and other features to assist in software development. For example, IDE 106 and UCE 107 may provide a File Explorer, a Code Editor, a Debugger, a Compiler, a Source Control component, etc. In alternative embodiments, UCE 107 may be instantiated as a standalone instance separate from the IDE 106.

Upon invocation of a UCE 107 instance, UCE UI 102 corresponding to the UCE 107 may be displayed on user device 104. For example, the UI 102 may be displayed on a display or other output device associated with user device 104. In certain implementations, the UI 102 may be browser-based and may be displayed by a browser 103 executed by user device 104.

User 101 may interact with UCE 107 via UI 102. User inputs provided via UI 102 may be communicated from user device 104 to system 109 and to UCE 107 instance. Responses from UCE 107 instance may be communicated to user device 104 and displayed via UI 102.

As disclosed herein, UI 102 associated with UCE 107 provides a single common user interface that a user 101 can use to edit existing artifacts or author/create new artifacts associated with multiple cloud services. The services in the multiple cloud services may be provided by one or more cloud service providers (CSPs).

A CSP generally provides infrastructure (also referred to as cloud infrastructure) that is used by the CSP to provide one or more cloud services. The infrastructure provided by a CSP may include compute, storage, networking, and other types of resources that are used to provide the cloud services. One or more customers of the CSP may subscribe to these cloud services. These cloud services may include various different types of cloud services such as Software-as-a-Service (SaaS), Platform-as-a-Service (PaaS), Infrastructure-as-a-Service (IaaS), Database-as-a-Service (DBaaS), and various other types of cloud services that can be subscribed to by one or more customers of the CSP.

In the embodiment depicted in FIG. 1, a first cloud services provider CSP_A may provide a set of cloud services including cloud service S1. A second cloud services provider CSP_B may offer another set of cloud services including cloud services S2 and S3. CSP_A infrastructure 110 provided by CSP_A includes S1 infrastructure 112 that is used for providing cloud service S1. As shown, the S1 infrastructure 112 includes a repository 114 that stores one or more artifacts 116 associated with service S1. These artifacts include, for example, artifacts S1A1 (artifact A1 associated with Service 1), S1A2 (artifact A2 associated with Service 1), and so on. CSP_B infrastructure 120 provided by CSP_B includes infrastructure 122 that is used for providing cloud service S2 and infrastructure 132 that is used for providing cloud service S3. S2 infrastructure 122 includes a repository 124 that stores one or more artifacts 126 associated with service S2. These artifacts include, for example, artifacts S2A1 (artifact A1 associated with Service 2), S2A2 (artifact A2 associated with Service 2), and so on. S3 infrastructure 132 includes an artifacts or code repository 134 that stores one or more artifacts 136 associated with service S3. These artifacts include, for example, artifacts S3A1 (artifact A1 associated with Service 3), S3A2 (artifact A2 associated with Service 3), and so on. The embodiment depicted in FIG. 1 is not meant to be limiting. In further implementations, a cloud service may have multiple repositories.

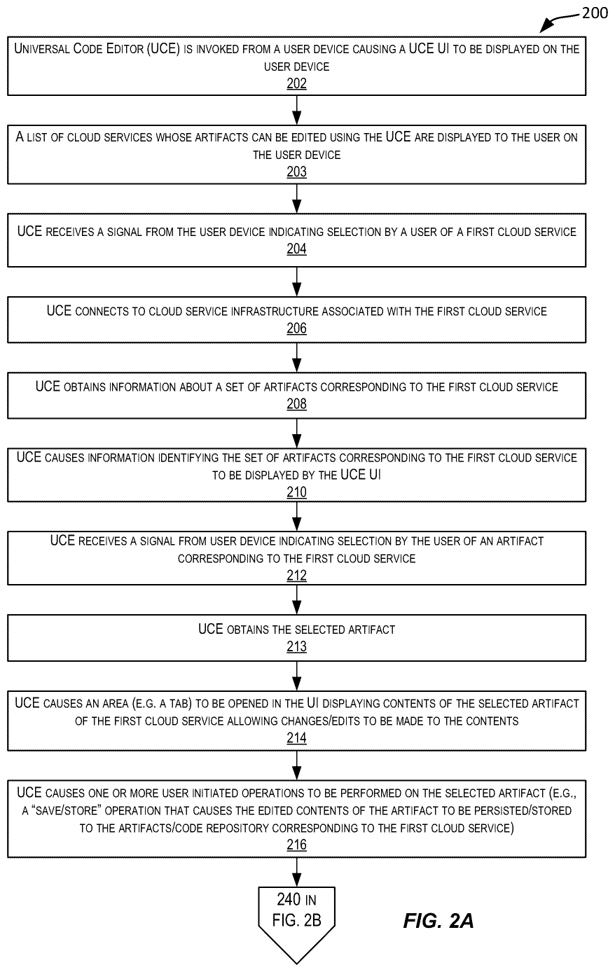

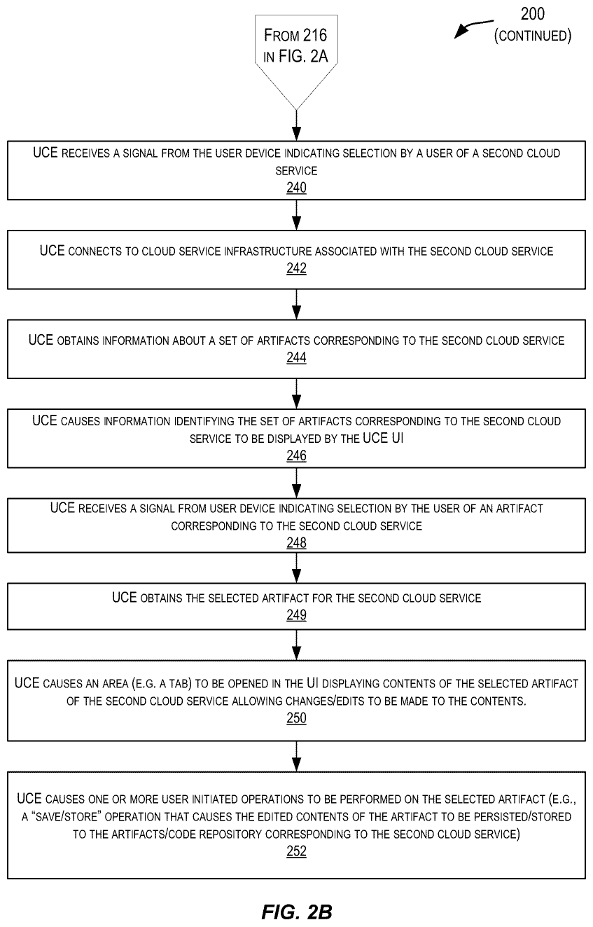

User 101 may use UI 102 provided by the same UCE 107 instance to edit artifacts belonging to multiple different cloud services, such artifacts belonging to S1, S2, or S3. The manner in which this is achieved is described below with respect to FIGS. 2A, 2B, 3A-3F, and FIG. 4, and the accompanying description.

Different types of users may use UCE 107. In one use case, the user 101 may be a developer responsible for developing code, debugging code, or maintaining code for one or more cloud services. For example, the user 101 may be a developer for service S2 and S3 offered by CSP_B. In another use case, the user 101 may be a system administrator, a performance engineer, or a maintenance engineer for a CSP and tasked with maintaining and debugging the code associated with the various cloud services provided by the CSP.

In yet another use case, user 101 may be a software developer of a customer of a CSP, where the customer has subscribed to multiple cloud services from one or more CSPs. For example, the customer may use the multiple cloud services to implement a process flow for the customer, which may require the cloud services to interact with each other. As a result, the customer may have to make customer-specific code modifications to code bases associated with multiple cloud services' code to enable interactions between the services. The user 101 may be an engineer or a developer of the customer tasked with making such changes to the code of multiple services. By enabling code for multiple cloud services to be edited using a common UI 102 associated with a single instance of UCE 107, the developer's efficiency and accuracy in making such code changes is increased. The developer is now able to make such code changes in parallel using a common tool. This was not possible in the past.

In certain implementations, UCE 107 may use a plugin architecture that allows UCE 107 to communicate with various cloud service infrastructure systems corresponding to the various cloud services whose artifacts can be edited using UCE 107. For example, in FIG. 1, UCE 107 uses: a plugin 108A to communicate with cloud service S1 infrastructure 112 that is used for Service S1 provided by a cloud service provider CSP_A; a plugin 108B to communicate with cloud service S2 infrastructure 122 that is used for cloud service S2; and a plugin 108C to communicate with cloud service S3 infrastructure 132 that is used for cloud Service S3. In other implementations, a plugin may also enable UCE 107 to connect to and communicate with infrastructures providing multiple different cloud services.

A plugin architecture enables new cloud services to be easily integrated with and supported by UCE 107. by providing a plugin specific to the new cloud service. For example, for a new cloud service to be integrated with UCE 107, a plugin for the new cloud service can be registered with UCE 107, which then uses the plugin to communicate with the infrastructure for the new cloud service. The plugin “plugs into” UCE 107, and via the plugin, UCE 107 can connect to and communicate with a code base or registry for the new cloud service. In this manner, new cloud services can be easily brought under the umbrella of UCE 107.

FIGS. 2A and 2B depict a simplified flowchart 200 depicting processing performed by a UCE while enabling editing of artifacts from multiple cloud services according to certain embodiments. The processing depicted in FIGS. 2A and 2B may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIGS. 2A and 2B and described below is intended to be illustrative and non-limiting. Although FIGS. 2A and 2B depict the various processing steps occurring in a particular sequence or order, this is not intended to be limiting. In certain alternative embodiments, the processing may be performed in some different order or some steps may also be performed in parallel. In certain embodiments, such as in the embodiment depicted in FIG. 1, the processing depicted in FIGS. 2A and 2B may be performed by or caused to be performed by UCE 107.

Processing may be initiated when a user 101 invokes a UCE 107 using a user device 104. Accordingly, at 202, a Universal Code Editor (UCE) is invoked from a user device causing a UCE UI to be displayed on the user device. In certain implementations, a UCE instance may be invoked on a computer system such as system 109 depicted in FIG. 1. In some other implementations, a UCE instance may also be executed on the user device itself. The UCE UI may be a graphical user interface (GUI) that is displayed on the user device. In certain implementations, the UCE may be browser-based and the UCE UI may be displayed by a browser executing on the user device.

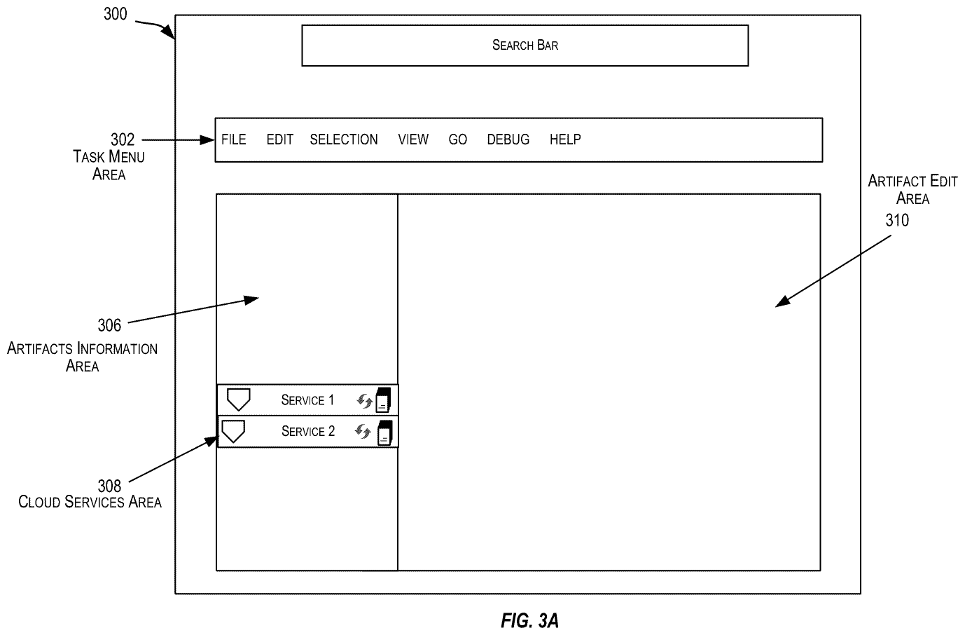

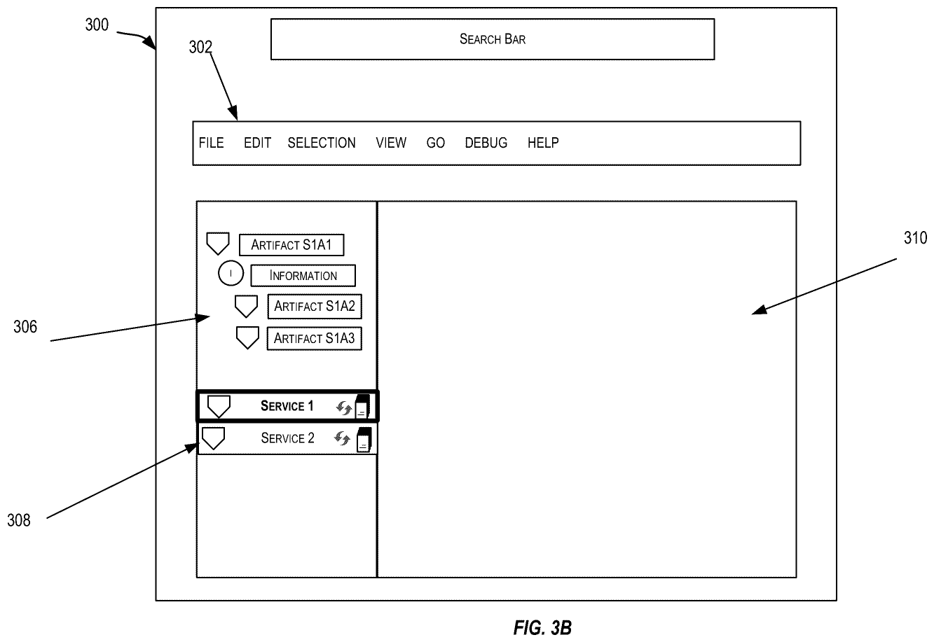

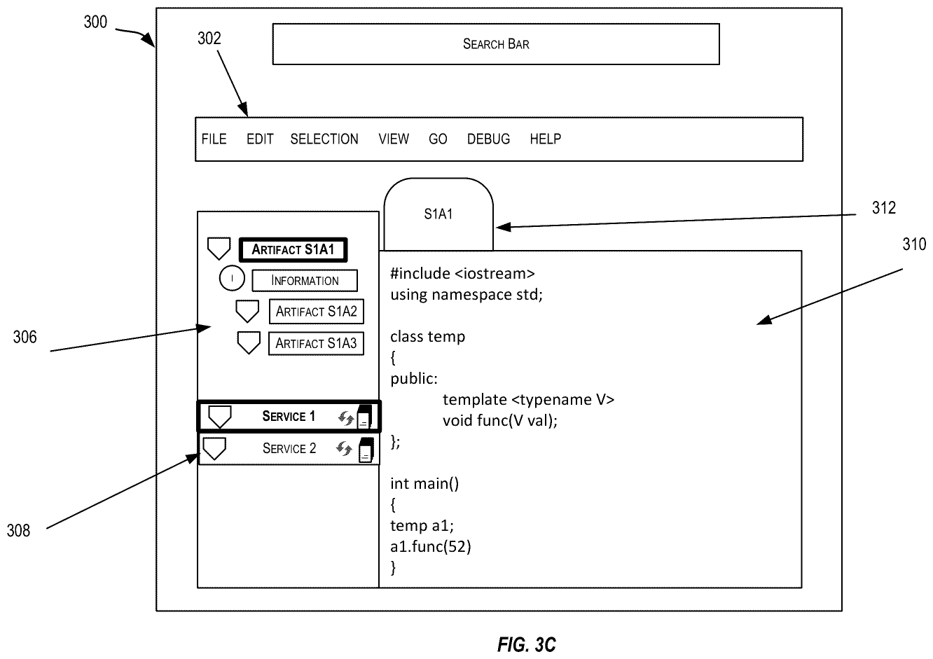

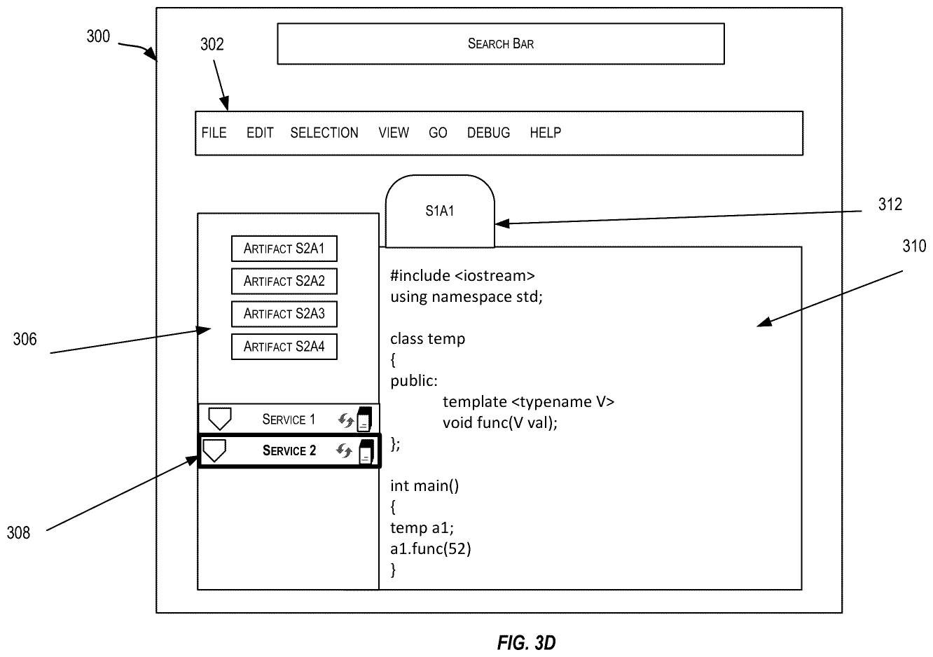

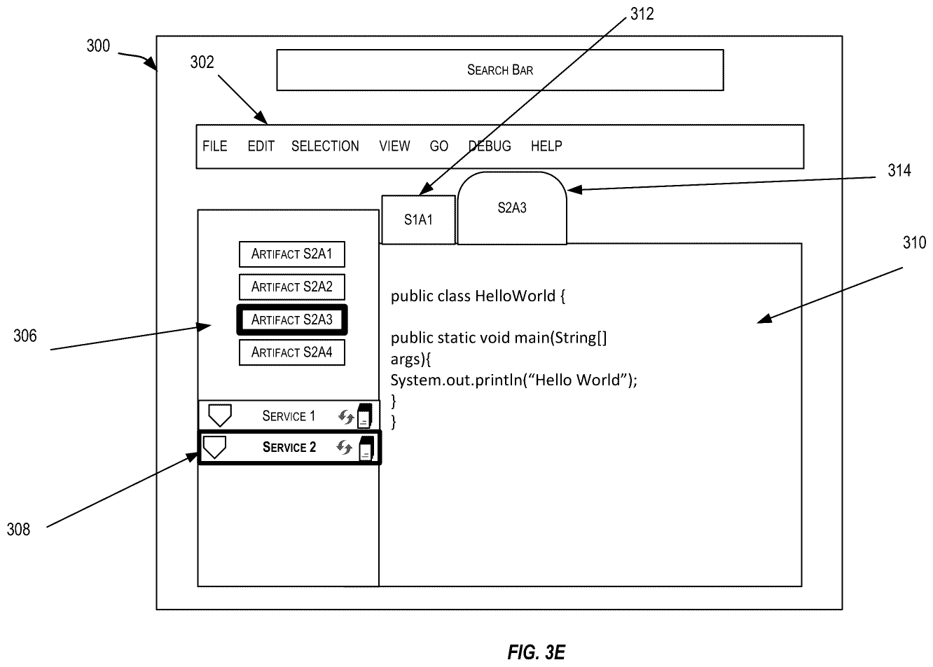

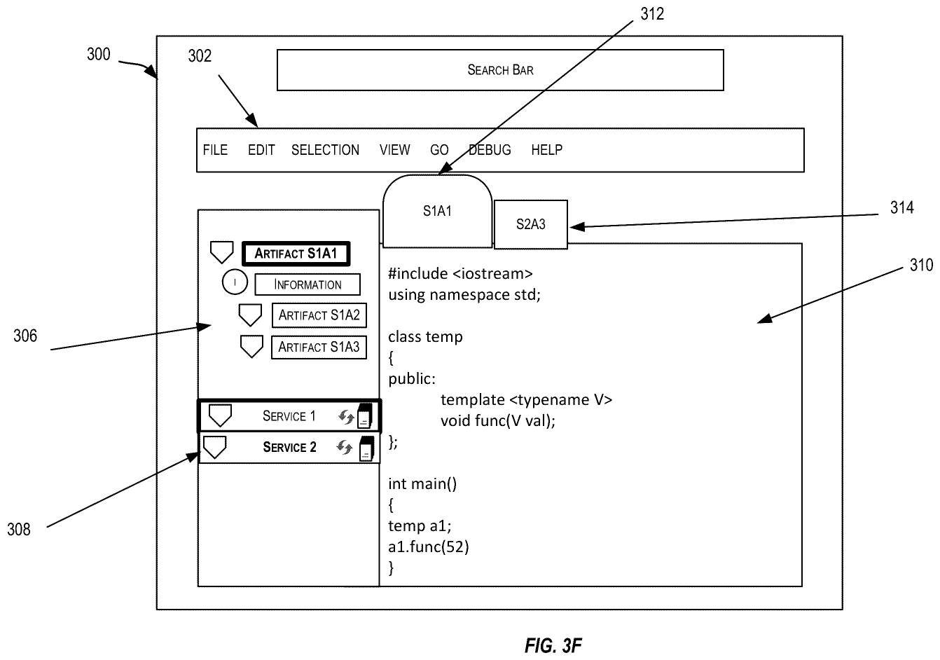

In certain embodiments, the UCE UI has multiple GUI areas including, but not limited to, a cloud services area, an artifacts information area, one or more artifact edit areas, a task menu area, and other areas. The UCE UI may also include search fields, drop down menus, and icons that allow for other functionality such as saving progress, sending messages, contacting support, and others. One or more cloud services whose artifacts are editable via the UCE may be displayed in the cloud services area of the UI. Further details on examples of UCE UI are depicted in FIGS. 3A-3F and described below.

At 203, a list of cloud services supported by the UCE may be displayed by a UCE UI displayed on the user device. In certain implementations, the list of cloud services may be displayed in the cloud services area of the UI. A cloud service is supported by the UCE if a user can user can use the UCE and its associated UI to edit artifacts associated with that cloud service.

At 204, the UCE may receive a signal from the user device indicating selection by the user of a particular cloud service whose related artifact the user wishes to edit. For example, the user may, via the UCE UI displayed on the user device, select a particular cloud service from the list of cloud services displayed in the cloud services area of the UI. A signal indicative of the particular cloud service selected by the user may then be communicated from the user device to the UCE. For purposes of explaining the teachings described herein, the particular cloud service selected in 204 is referred to as the “first cloud service” to differentiate it from a second cloud service that may be selected by the user via the UI, as discussed below.

At 206, responsive to receiving the signal indicative of selection of the first cloud service in 204, the UCE establishes a connection to the cloud service infrastructure associated with the first cloud service. In certain embodiments, the UCE uses a plugin corresponding to the selected first cloud service to connect to and communicate with the cloud service infrastructure associated with the first cloud service. The cloud service infrastructure for the first cloud service may comprise one or more hardware or software components including a repository where artifacts corresponding to the first cloud service may be stored.

For example, in the embodiment depicted in FIG. 1, user 101 may select cloud service S1 via UI 102 displayed on user device 104. UCE 107 receives a signal indicative of the selection and, in response, connects to S1 infrastructure 112. As depicted in FIG. 1, S1 infrastructure 112 includes repository 114 storing artifacts 116 corresponding to the S1 cloud service. In certain implementations, UCE 107 may connect to S1 infrastructure 112 using plugin 108A corresponding to the S1 cloud service.

At 208, the UCE obtains information about a set of artifacts corresponding to the first cloud service from the first cloud service infrastructure. Various different communication techniques and protocols may be used for receiving this information from the first cloud service infrastructure. For example, for the embodiment depicted in FIG. 1, UCE 107 may receive information from S1 infrastructure 112 about various artifacts 116 related to the S1 cloud service and stored in repository 114.

At 210, based on the information received in 208, the UCE causes information identifying the set of artifacts corresponding to the first cloud service to be displayed by the UCE UI. In certain implementations, the information identifying the artifacts may be displayed in an artifacts information area of the UI. For example, in the embodiment depicted in FIG. 1, information identifying artifacts 116 (e.g., S1A1, S1A2, etc.) corresponding to the service S1 may be displayed in the artifacts information area of UI 102.

The user may then select a particular artifact to be edited from the list of artifacts displayed in the artifacts information area. Accordingly, at 212, the UCE receives a signal from the user device indicating selection by the user, from the artifacts information area, of a particular artifact from the list of artifacts corresponding to the first cloud service.

At 213, the UCE obtains the artifact selected by the user. There are various ways in which the UCE may obtain the selected artifact. In certain implementations, the UCE may access the repository in the infrastructure for the service where the artifact is stored and retrieve the selected artifact from that stored location. In some other implementations, the particular first service may provide a set of APIs usable by the UCE. The UCE may call a particular API that causes the service infrastructure for the first cloud service (e.g., S1 infrastructure 112 for service S1) to communicate the selected artifact to the UCE.

At 214, the UCE causes an artifact edit area (e.g., a window or a tab in the browser UI) to be opened in the UI and causes the contents of the selected artifact of the first cloud service to be displayed in the artifact edit area. The user can then make changes/edits to the contents of the artifact displayed in the artifact edit area of the UCE UI. For example, in the embodiment depicted in FIG. 1, if the user selected artifact S1A1 of service S1, then in 214, an artifact edit area is opened within the UCE UI and the contents of S1A1 are displayed in the artifact edit area, where the user can edit the contents.

In addition to editing the contents of the artifact, the user may also optionally request one or more operations to be performed on the selected artifact. For example, the user may select one or more operations to be performed from a task menu area of the UCE UI and those selected operations are then performed by the UCE on the selected artifact. Accordingly, in 216, responsive to one or more operations selected by the user via the UCE UI, the UCE may perform the corresponding operations on the selected artifact. For example, if the user selects a “Save/Store” operation, the contents of the artifact, as present at the time of the selection of the operation, are persisted or stored to the artifacts/code repository corresponding to the first cloud service. The plug-in corresponding to the first cloud service may be used to facilitate saving of the contents of the artifact to the artifacts repository in the first cloud service infrastructure. For example, for the embodiment depicted in FIG. 1, if the contents of S1A1 were being edited by the user via the UCE UI, upon selecting the “Save/Store” operation from a list of operations selectable by the user from the UI, the edited contents of the artifact S1A1 are stored to repository 114 in S1 infrastructure 112.

As indicated above, in certain implementations, the service may provide APIs that enable the UCE to invoke the operations to be performed on the selected artifact. For example, the UCE may invoke a “Save” API and provide the artifact to be saved as a parameter to that API. Calling the API may cause communications between the UCE and the service infrastructure, which results in the artifact being stored to the appropriate repository within the infrastructure for the service. In a similar manner, other APIs may be provided for different operations.

While the contents of the selected artifact from the first cloud service are being edited in a first artifact edit area of the UI, the user may select additional artifacts for editing. These other artifacts may be from the same first cloud service or from different cloud services. For example, FIG. 2B, which is a continuation of flowchart 200 depicted in FIG. 2A, depicts processing that is performed when the user selects a second artifact from a second cloud service for editing. The description for the processing performed for the artifact of the second cloud service and depicted in 240, 242, 244, 246, 248, 249, 250, and 252, is quite similar to the processing depicted in 204, 206, 208, 210, 212, 213, 214, and 216, respectively, as described above.

At 240, the UCE may receive a signal from the user device indicating selection by the user of a second cloud service from the list of cloud services displayed in the cloud services area of the UI, where the second cloud service is different from the first cloud service. For example, the user may have previously selected the S2 service provided by CSP_B and now selects cloud service S3 provided by CSP_B. As another example, the user may have previously selected the S2 service provided by CSP_B and now selects cloud service S1 provided by CSP_A. The second selected cloud service may be provided by the same CSP or a different CSP from the CSP providing the first selected cloud service.

At 242, responsive to receiving the signal indicative of selection of the second cloud service in 240, the UCE establishes a connection to the cloud service infrastructure associated with the second cloud service. In certain embodiments, the UCE uses a plugin corresponding to the second cloud service to connect to and communicate with the second cloud service infrastructure. The cloud service infrastructure for the second cloud service may comprise one or more hardware or software components including a repository where artifacts corresponding to the second cloud service may be stored.

For example, in the embodiment depicted in FIG. 1, user 101 may have previously selected cloud service S1, and now selects cloud service S2 via UI 102 displayed on user device 104. UCE 107 receives a signal indicative of the selection and, in response, connects to S2 infrastructure 122. As depicted in FIG. 1, S2 infrastructure 122 includes repository 124 storing a bunch of artifacts 126 corresponding to the S2 cloud service. In certain implementations, the UCE 107 may connect to the S2 infrastructure 122 using plugin 108B corresponding to the S2 cloud service.

At 244, the UCE obtains information about a set of artifacts corresponding to the second cloud service from the second cloud service infrastructure. Various different communication techniques and protocols may be used for receiving this information from the second cloud service infrastructure. For example, for the embodiment depicted in FIG. 1, UCE 107 may receive information from S2 infrastructure 122 about various artifacts 126 related to the S2 cloud service and stored in repository 124.

At 246, based on the information received in 244, the UCE causes information identifying the set of artifacts corresponding to the second cloud service to be displayed by the UCE UI. In certain implementations, the information identifying the artifacts may be displayed in the artifacts information area of the UI. For example, in the embodiment depicted in FIG. 1, information identifying artifacts 126 (e.g., S2A1, S2A2, etc.) corresponding to the service S2 may be displayed in the artifacts information area of UI 102. If there was information previously displayed om the artifacts information area (e.g., a list of artifacts corresponding to the first cloud service per 210), then, in 246, any previously displayed information is replaced with information about artifacts corresponding to the currently selected second cloud service.

The user may then, from the artifacts information area, select a particular artifact to be edited from the list of artifacts associated with the second cloud service that are displayed in the artifacts information area. At 248, the UCE receives a signal from the user device indicating selection by the user, from the artifacts information area, of a particular artifact from the list of artifacts corresponding to the second cloud service.

At 249, the UCE obtains the artifact of the second cloud service selected by the user. There are various ways in which the UCE may obtain the selected artifact. In certain implementations, the UCE may access the repository in the infrastructure for the service where the artifact is stored and retrieve the selected artifact from that stored location. In some other implementations, the second service may provide a set of APIs usable by the UCE. The UCE may call a particular API that causes the service infrastructure for the second service (e.g., infrastructure 122 for service S2) to communicate the selected artifact to the UCE.

At 250, the UCE causes another artifact edit area (i.e., another window or tab in addition to the artifact edit area showing contents of the selected artifact for the first cloud service) to be opened in the UI and causes the contents of the selected artifact of the second cloud service to be displayed in this second artifact edit area. The user can then make changes/edits to the contents of the artifact of the second cloud service in the newly opened second artifact edit area. For example, in the embodiment depicted in FIG. 1, if the user selected artifact S2A1 of service S2, then in 250, an artifact edit area is opened within the UCE UI and the contents of artifact S2A1 are displayed in the artifact edit area, where the user can edit the contents.

At this point, the UCE UI may display two artifact edit areas, a first area showing the contents of the selected artifact of the first cloud service, and a second area showing the contents of the selected artifact of the second cloud service. In this manner, the user can make edits to two different artifacts from two different cloud services at the same time using the same UCE instance. In a similar manner, the user can open additional artifacts for editing from the first cloud service, from the second cloud service, or from other cloud services. The same UCE instance thus allows artifacts from one or more cloud services to be edited in parallel.

For any of the artifacts being edited, in addition to editing the contents of the artifact, the user may also optionally request one or more operations to be performed on a selected artifact. For example, the user may select one or more operations to be performed from the task menu area of the UI and those operations are then performed by the UCE on a selected artifact. Accordingly, in 252, responsive to one or more operations selected by the user via the UCE UI, the UCE may perform user-initiated actions on the selected artifact of the second cloud service. For example, if the user selects a “Save/Store” operation, the contents of the artifact, as present at the time of the selection of the operation, are persisted to the artifacts/code repository corresponding to the second cloud service. The plug-in corresponding to the second cloud service may be used to facilitate saving of the contents of the artifact to the artifacts repository in the second cloud service infrastructure. For example, for the embodiment depicted in FIG. 1, if the contents of S2A1 were being edited by the user via the UCE UI, upon selecting the “Save/Store” operation from a list of operations selectable by the user from the UI, the edited contents of the artifact S2A1 are stored to repository 124 in S2 infrastructure 122.

FIGS. 3A-3F show examples of illustrative UCE UIs (e.g., graphical user interfaces GUIs) that may be associated with a UCE according to certain embodiments. UI 300 depicted in FIG. 3A, for example, may be displayed on a screen of a user device when a UCE is invoked. UI 300 depicted in FIGS. 3A-3F is merely an example and is not intended to unduly limit the scope of claimed embodiments. Many variations, alternatives, and modifications are possible in alternative embodiments.

UCE UI 300 may include various areas displaying various pieces of information related to one or more cloud services and allowing users to perform various actions with respect to the cloud services, including editing one or more artifacts associated with the cloud services. In the embodiment depicted in FIGS. 3A-3F, UI 300 includes a cloud services area 308, an artifacts information area 306, one or more artifact edit areas 310, a task menu area 302, and others (e.g., a search bar). When the UCE is first invoked and the UI displayed, a list of cloud services whose artifacts can be edited using the UCE may be displayed in cloud services area 308. Each cloud service may be identified by an identifier. In the example in FIG. 3A, two cloud services “Service 1” and “Service 2 are displayed. For a selected service, information listing artifacts associated with the selected cloud service may be displayed in artifacts information area 306. The artifacts information area 306 and the artifact edit area 310 may initially be empty when a user of the UCE has not made any selections as yet.

The cloud services that are displayed in cloud services area 308 may include those cloud services that have been integrated with the UCE. For example, in certain implementations, the cloud services that have been integrated may correspond to those cloud services for which a plugin adapter is available to the UCE. Additional cloud services may be integrated with the UCE by providing plugins for those additional services to the UCE. In certain implementations, operations selected from task menu area 302 may be used to integrate additional cloud services with the UCE. For example, task menu area 302 may provide user-selectable options for selecting a cloud service to be integrated with the UCE. In response to selection of such an option, one or more UIs may be presented to the user for entering information related to the new cloud service to be integrated with the UCE.

A user of the UCE may select a particular cloud service from the list of cloud services displayed in cloud services area 308 in FIG. 3B. For example, FIG. 3B shows UCE UI 300 after the user has selected cloud service “Service 1” in FIG. 3A. The identifier for the selected cloud service displayed in cloud services area 308 may be visually highlighted to indicate that the user has selected it. In response to the user selection, the UCE connects to the infrastructure for the selected cloud service (Service 1) and obtains information about artifacts stored in an artifacts repository for the selected cloud service (Service 1). Information obtained related to the artifacts for Service 1 is then displayed in artifacts information area 306. The displayed information may include a list of artifacts for Service 1, and various pieces of information for an artifact. For example, the information displayed for an artifact may include name of the artifact, size of the artifact, a directory structure associated with the artifact (e.g., where the artifact is stored in Service 1's repository, and other information.

For example, as shown in FIG. 3B, information identifying three artifacts associated with Service 1, namely S1A1, S1A2, and S1A3, are displayed in artifacts information area 306. Information regarding one or more the artifacts is also displayed. The hierarchical nature of the artifacts is also displayed, where one artifact can include another artifact. The hierarchical nature may correspond to a directory structure of the Service 1's repository where the artifacts are stored. For example, in the embodiment in FIG. 3B, artifacts S1A2 and S1A3 are in a sub-directory of the directory corresponding to artifact S1A1. Various pieces of information may be displayed for each artifact.

The user may then, from the list of artifacts displayed in artifacts information area 306, select a particular artifact for editing. FIG. 3C shows an illustrative example of UCE UI 300 where the user has selected a particular artifact for editing. For example, in FIG. 3C, the user has selected artifact S1A1 (artifact A1 of cloud service S1) from area 306 for editing. The selected artifact may be highlighted in area 306 to indicate its selection. Responsive to selection of an artifact, an artifact edit area 310 is opened and contents of the selected artifact are displayed in area 310. In FIG. 3C, the artifact edit area opened for an artifact is in the form of a new tab 312. The contents displayed in the artifact edit area may include, for example, code content of artifact S1A1. Artifact edit area 310 enables the user of the UCE to make edits to the contents of the artifact displayed in artifact edit area 310. In certain implementations, artifact edit area 310 is a text editor that provides various editing features that the user can use to edit the contents of the artifact. As the user makes the edits, the edits are displayed in the artifact edit area 310 in real-time or near real-time to the user. Artifact edit area 310 may provide various features that are commonly provided by a code editor, such as a spell check feature that highlights misspelled words, the ability to show code variables and code constructs (e.g., loops) in different colors, auto indentation for writing code, special color to show comments, and the like.

In addition to providing the ability to edit the contents of a selected artifact for a cloud service, the UCE UI may also enable the user to perform one or more actions on an artifact being edited. For example, in certain implementations, the UI may provide a task menu area 302 that provides a set of actions that a user can select from to perform on an artifact. As can be seen from UI 300 and depicted in FIGS. 3A-3F, task menu area 302 provides various a set of menu options that are user-selectable. A menu option, when selected by the user, may display additional sub-options, such as via a drop-down menu. The user may select a particular cloud service from the cloud services displayed in cloud services area 308 or select an artifact from artifacts information area 306 or by selecting a particular tab corresponding to the artifact, and then select an action to be performed on the selected cloud service or the selected artifact from task menu area 302. For example, the user may select a “SAVE” action to save the contents of the selected artifact being edited. Other examples of actions that can be selected from task menu area 302 include, without limitation, various actions related to file operations (e.g., saving an artifact file, copying an artifact file, deleting an artifact file, etc.), actions related to editing an artifact, actions related to selecting a cloud service or an artifact, view related actions corresponding to various view options for viewing artifacts, various actions for executing an artifact, actions for debugging an artifact, help-related actions, and others.

The UCE UI enables a user to edit multiple artifacts in parallel via the same UI 300. The multiple artifacts that are edited can be artifacts from the same cloud service or from different cloud services. The different cloud services can be provided by the same cloud services provider or by different cloud services providers.

For example, while editing an artifact corresponding to a particular cloud service, the user may select another artifact to be edited from the same particular cloud service or from a different cloud service. For example, in FIG. 3D, while the contents of artifact S1A1 are being edited in tab 312, the user may decide to select cloud service “Service 2” from cloud services area 308. This selection is shown by “Service 2” being highlighted in FIG. 3D. When the user selects “Service 2”, the UCE connects to the cloud infrastructure and the artifacts repository for “Service 2” and retrieves information about artifacts corresponding to “Service 2.” Artifacts information area 306 is now populated with information about artifacts associated with cloud service “Service 2”. As shown in FIG. 3D, in artifacts information area 306, information regarding the artifacts associated with “Service 1” is now replaced with information regarding the artifacts for “Service 2”. As shown in FIG. 3E, four artifacts are listed for Service 2, namely, S2A1, S2A2, S2A3, and S2A4. It is to be noted that tab 312 corresponding to the artifact S1A1 of Service 1 remains to be displayed.

The user may then select an artifact of “Service 2” for editing from area 306. In the example shown in FIG. 3E, the user has selected artifact S2A3 (artifact A3 of Service 2) from area 306 for editing. Responsive to the user's selection of artifact S2A3, the UCE obtains the selected artifact from the Service 2 repository storing the artifact, opens and displays a new artifact edit area 310 (e.g., a new tab 314), and the contents of the selected artifact S2A3 are displayed in this new tab 314. The user can then edit the contents of artifact S2A3 in tab 314. Like tab 312, tab 314 provides various features for editing the contents of the artifact displayed in tab 314.

There are various ways in which multiple tabs (or artifact edit areas) may be displayed by UI 300. In certain implementations, a foreground/background concept may be used by the UCE for displaying multiple tabs in UCE UI 300. In one such implementation, the last selected or opened tab is brought to the foreground and other tabs are pushed to the background. For a tab pushed to the background, the contents displayed in that tab are no longer displayed by UI 300. Instead, the contents in the foreground tab are displayed by UI 300. For example, as shown in FIG. 3E, tab 312 that provided an edit area for displaying and editing the contents of artifact S1A1 associated with “Service 1” is pushed to the background, and tab 314 displaying and enabling the editing of contents of artifact S2A3 associated with “Service 2” is made the foreground tab. In such embodiments, at any time, the contents of the artifact displayed in the foreground tab are editable by the user. One or more actions selected by a user from task menu area 302 are also performed on the artifact corresponding to the foreground tab. For example, the user can make edits to the contents of S2A3, and optionally perform operations on S2A3. For example, if the user selects a “FILE/Save” operation for S2A3, the contents of the artifact, as present at the time of the selection of the operation, are persisted to the artifacts/code repository of the “Service 2” cloud service.

A user can make a background tab a foreground tab by selecting that tab. In response, the UI 300 is updated such that the selected tab, which was previously a background tab, is now made the foreground tab and the most recent foreground tab is pushed to the background and made the background tab. The user can then continue to edit the contents of an artifact displayed in the foreground tab. In this manner, multiple artifacts may be open at the same time, each artifact being displayed in a separate tab of the UI. By switching between the multiple tabs, the user can edit multiple artifacts via the UI associated with the same UCE instance.

For example, the user can switch between the edit areas for S1A1 and S2A3 by toggling between tabs 312 and 314. For example, in FIG. 3F, the user has selected tab 312 corresponding to the edit area showing the contents of S1A1. As a result of selection of tab 312, tab 312 and its associated edit area showing the contents of artifact S1A1 is now made the foreground tab and its contents displayed; tab 314 corresponding to the edit area for artifact S2A3 is pushed to the background. Further, responsive to selection of tab 312, the information displayed in artifacts information area 306 is updated to show information regarding the artifacts for “Service 1”. The service highlighted in cloud service area 308 is also updated to now show “Service 1” as being selected instead of “Service 2”.

In some other implementations, multiple tabs (or artifact edit areas) can be in the foreground at the same time. For example, two tabs and their contents may be displayed side-by-side, thereby enabling the user to edit the contents displayed by the two tabs simultaneously. The ability to display multiple foreground tabs may be enabled in use cases where there is sufficient display area available on the user device for displaying multiple side-by-side foreground artifact edit areas in UI 300.

In the manner described above, UCE UI 300 allows the user to transition between the different artifacts being edited by selecting the tabs corresponding to the edit areas for those artifacts. Edits can be made to an artifact independent from edits made to another artifact for artifacts belonging to the same cloud service or for artifacts from different cloud services, where the different services are provided by the same CSP or different CSPs. The user could also copy a portion of contents of a first artifact being edited and paste the copied contents into a second artifact being edited, where the first artifact and the second artifact can be from the same cloud service or from different cloud services, where the different services are provided by the same CSP or different CSPs. This is very convenient for the user since the UCE now enables the user to easily make similar changes across artifacts across different cloud services.

The user can also now more conveniently make complementary changes across artifacts from different cloud services. Complementary changes are changes where a change to an artifact in one cloud service triggers a change to an artifact in a different second cloud service. This usually occurs when the first cloud service and the second cloud service interact with each other as part of a process flow. Per the teachings described herein, this can now be done by invoking a single instance of the UCE and being able to edit the artifacts from the different cloud services using the same UI of the UCE. This was not possible in the past. This makes the process of editing artifacts from different cloud services very streamlined, simple, faster, and is less prone to errors being introduced while making the edits.

The user may close out tabs 312 or 314 to close out the edit sessions for the artifacts. In certain implementations, upon closing a tab, if the latest artifact contents of the tab have not been saved, the user may be prompted to save the contents. Upon selecting “yes,” the UCE causes the edited contents of the artifact to be saved to the repository of the cloud service where the artifact is stored.

As described above, a user can select a particular cloud service from a list of cloud services displayed in cloud services area 308. One or more artifacts corresponding to the selected cloud service are then displayed in artifacts information area 306. The user can then select a particular artifact from the artifacts information area 306. Responsive to selection of a particular artifact, an artifact edit area 310 is opened for the selected artifact and the contents of the selected artifact are displayed in the edit area. The user can then make edits to the contents of the artifact in the edit area. Multiple artifacts from one or different cloud services can be opened simultaneously using the same UCE instance.

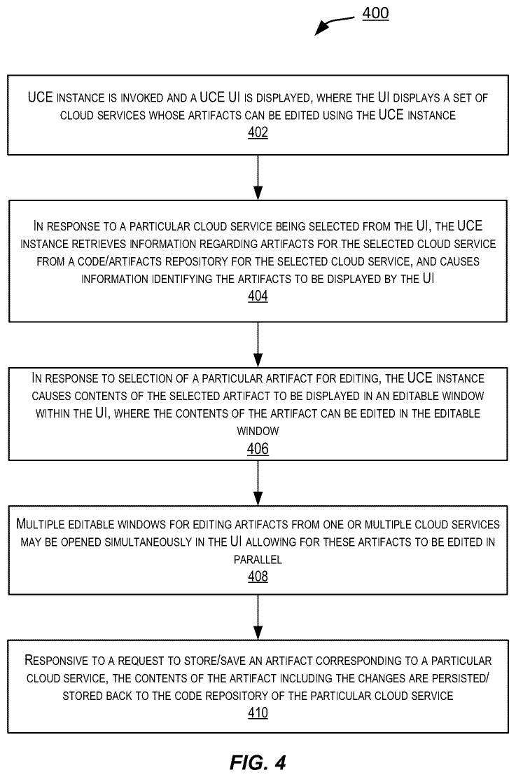

FIG. 4 depicts a simplified high-level flowchart 400 depicting processing performed by a UCE according to certain embodiments. The processing depicted in FIG. 4 may be implemented in software (e.g., code, instructions, program) executed by one or more processing units (e.g., processors, cores) of the respective systems, using hardware, or combinations thereof The software may be stored on a non-transitory storage medium (e.g., on a memory device). The method presented in FIG. 4 and described below is intended to be illustrative and non-limiting. Although FIG. 4 depicts the various processing steps occurring in a particular sequence or order, this is not intended to be limiting. In certain alternative embodiments, the processing may be performed in some different order or some steps may also be performed in parallel. In certain embodiments, such as in the embodiment depicted in FIG. 1, the processing depicted in FIG. 4 may be performed by or caused to be performed by UCE 107.

At 402, a UCE instance is invoked and this causes a UI associated with the UCE to be displayed, for example, on a user device. The UI displays a set of cloud services whose artifacts can be edited using the UCE instance.

At 404, in response to a particular cloud service being selected via the UI, the UCE obtains information regarding artifacts for the selected cloud service from a code/artifacts repository for the selected cloud service, and causes information identifying the artifacts to be displayed by the UI.

At 406, in response to a particular artifact being selected for editing via the UI, the UCE instance causes contents of the selected artifact to be displayed in an editable window within the UI. A user can then edit the artifact contents in this edit window.

At 408, multiple edit areas or windows for editing artifacts from one or more cloud services may be opened simultaneously in the UI. These windows allow the artifacts displayed in the windows to be edited via the UI. Multiple artifacts may be edited in parallel.

In certain use cases, as part of 408, the user may select another cloud service that is different from the particular cloud service selected in 404. The UCE then obtains information regarding a set of artifacts associated with the another cloud service. A list of artifacts associated with the another service may be displayed in an artifacts information area of the UI. The user may then select a particular artifact from the displayed list of artifacts. A new edit area, in addition to the edit area displayed in 406, is then opened and displayed by the UCE UI, where the contents of the particular artifact of the another cloud service are displayed in the newly opened edit area. The user can now edit the contents of the particular artifact using this newly opened edit area.

At 410, responsive to a request to store/save an artifact being edited corresponding to a particular cloud service, the contents of the artifact including the changes are persisted/stored back to the code repository of the particular cloud service.

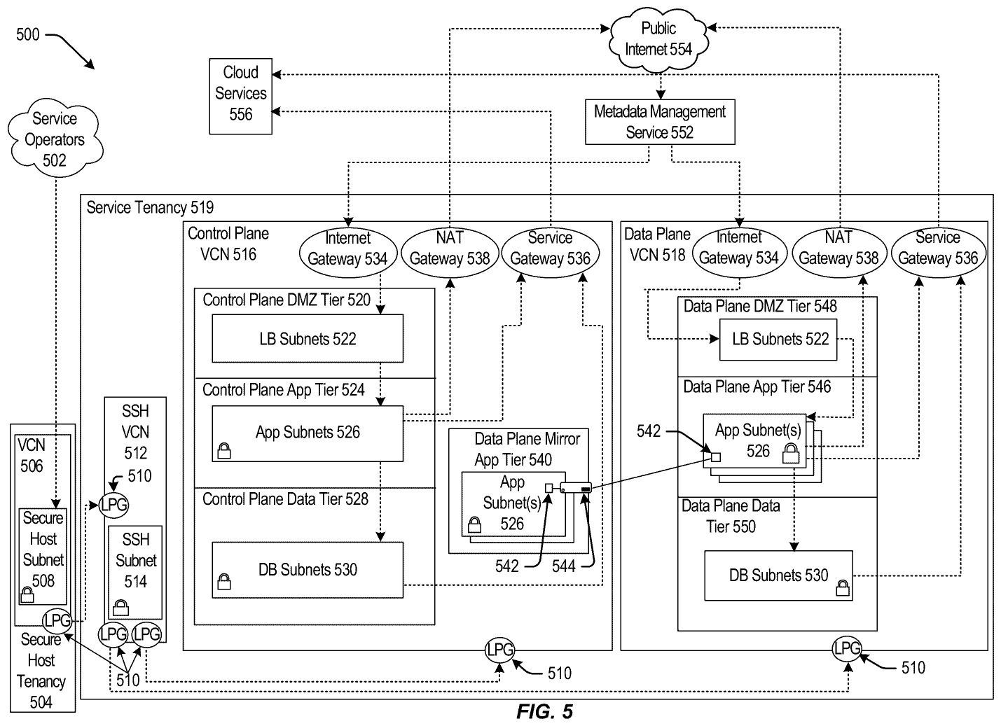

In certain implementations, the UCE functionality described above may be provided as a cloud service using cloud service infrastructure. Example of cloud infrastructures that may be used to provide the UCE functionality as a cloud service are depicted in FIGS. 5, 6, 7, and 8 and described below.

### Example Cloud Infrastructure Embodiments

As noted above, infrastructure as a cloud service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of cloud services to accompany those infrastructure components (e.g., billing, monitoring, logging, load balancing and clustering, etc.). Thus, as these cloud services may be policy-driven, IaaS users may be able to implement policies to drive load balancing to maintain application availability and performance.

In some instances, IaaS customers may access resources and cloud services through a wide area network (WAN), such as the Internet, and can use the cloud service provider's cloud services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the cloud service provider's cloud services to perform various functions, including balancing network traffic, troubleshooting application issues, monitoring performance, managing disaster recovery, etc.

In most cases, a cloud computing model will require the participation of a cloud service provider. The cloud service provider may, but need not be, a third-party cloud service that specializes in providing (e.g., offering, renting, selling) IaaS. An entity might also opt to deploy a private cloud, becoming its own provider of infrastructure cloud services.

In some examples, IaaS deployment is the process of putting a new application, or a new version of an application, onto a prepared application server or the like. It may also include the process of preparing the server (e.g., installing libraries, daemons, etc.). The cloud service provider often manages this, below the hypervisor layer (e.g., the servers, storage, network hardware, and virtualization). Thus, the customer may be responsible for handling (OS), middleware, and/or application deployment (e.g., on self-cloud service virtual machines (e.g., that can be spun up on demand) or the like.

In some examples, IaaS provisioning may refer to acquiring computers or virtual hosts for use, and even installing needed libraries or cloud services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new cloud services, changing cloud services, removing cloud services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, cloud service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 5 is a block diagram 500 illustrating an example pattern of an IaaS architecture, according to at least one embodiment. Cloud service operators 502 can be communicatively coupled to a secure host tenancy 504 that can include a virtual cloud network (VCN) 506 and a secure host subnet 508. In some examples, the cloud service operators 502 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message cloud service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 506 and/or the Internet.

The VCN 506 can include a local peering gateway (LPG) 510 that can be communicatively coupled to a secure shell (SSH) VCN 512 via an LPG 510 contained in the SSH VCN 512. The SSH VCN 512 can include an SSH subnet 514, and the SSH VCN 512 can be communicatively coupled to a control plane VCN 516 via the LPG 510 contained in the control plane VCN 516. Also, the SSH VCN 512 can be communicatively coupled to a data plane VCN 518 via an LPG 510. The control plane VCN 516 and the data plane VCN 518 can be contained in a cloud service tenancy 519 that can be owned and/or operated by the IaaS provider.

The control plane VCN 516 can include a control plane demilitarized zone (DMZ) tier 520 that acts as a perimeter network (e.g., portions of a corporate network between the corporate intranet and external networks). The DMZ-based servers may have restricted responsibilities and help keep breaches contained. Additionally, the DMZ tier 520 can include one or more load balancer (LB) subnet(s) 522, a control plane app tier 524 that can include app subnet(s) 526, a control plane data tier 528 that can include database (DB) subnet(s) 530 (e.g., frontend DB subnet(s) and/or backend DB subnet(s)). The LB subnet(s) 522 contained in the control plane DMZ tier 520 can be communicatively coupled to the app subnet(s) 526 contained in the control plane app tier 524 and an Internet gateway 534 that can be contained in the control plane VCN 516, and the app subnet(s) 526 can be communicatively coupled to the DB subnet(s) 530 contained in the control plane data tier 528 and a cloud service gateway 536 and a network address translation (NAT) gateway 538. The control plane VCN 516 can include the cloud service gateway 536 and the NAT gateway 538.

The control plane VCN 516 can include a data plane mirror app tier 540 that can include app subnet(s) 526. The app subnet(s) 526 contained in the data plane mirror app tier 540 can include a virtual network interface controller (VNIC) 542 that can execute a compute instance 544. The compute instance 544 can communicatively couple the app subnet(s) 526 of the data plane mirror app tier 540 to app subnet(s) 526 that can be contained in a data plane app tier 546.

The data plane VCN 518 can include the data plane app tier 546, a data plane DMZ tier 548, and a data plane data tier 550. The data plane DMZ tier 548 can include LB subnet(s) 522 that can be communicatively coupled to the app subnet(s) 526 of the data plane app tier 546 and the Internet gateway 534 of the data plane VCN 518. The app subnet(s) 526 can be communicatively coupled to the cloud service gateway 536 of the data plane VCN 518 and the NAT gateway 538 of the data plane VCN 518. The data plane data tier 550 can also include the DB subnet(s) 530 that can be communicatively coupled to the app subnet(s) 526 of the data plane app tier 546.

The Internet gateway 534 of the control plane VCN 516 and of the data plane VCN 518 can be communicatively coupled to a metadata management cloud service 552 that can be communicatively coupled to public Internet 554. Public Internet 554 can be communicatively coupled to the NAT gateway 538 of the control plane VCN 516 and of the data plane VCN 518. The cloud service gateway 536 of the control plane VCN 516 and of the data plane VCN 518 can be communicatively couple to cloud services 556.

In some examples, the cloud service gateway 536 of the control plane VCN 516 or of the data plane VCN 518 can make application programming interface (API) calls to cloud services 556 without going through public Internet 554. The API calls to cloud services 556 from the cloud service gateway 536 can be one-way: the cloud service gateway 536 can make API calls to cloud services 556, and cloud services 556 can send requested data to the cloud service gateway 536. But, cloud services 556 may not initiate API calls to the cloud service gateway 536.

In some examples, the secure host tenancy 504 can be directly connected to the cloud service tenancy 519, which may be otherwise isolated. The secure host subnet 508 can communicate with the SSH subnet 514 through an LPG 510 that may enable two-way communication over an otherwise isolated system. Connecting the secure host subnet 508 to the SSH subnet 514 may give the secure host subnet 508 access to other entities within the cloud service tenancy 519.

The control plane VCN 516 may allow users of the cloud service tenancy 519 to set up or otherwise provision desired resources. Desired resources provisioned in the control plane VCN 516 may be deployed or otherwise used in the data plane VCN 518. In some examples, the control plane VCN 516 can be isolated from the data plane VCN 518, and the data plane mirror app tier 540 of the control plane VCN 516 can communicate with the data plane app tier 546 of the data plane VCN 518 via VNICs 542 that can be contained in the data plane mirror app tier 540 and the data plane app tier 546.

In some examples, users of the system, or customers, can make requests, for example create, read, update, or delete (CRUD) operations, through public Internet 554 that can communicate the requests to the metadata management cloud service 552. The metadata management cloud service 552 can communicate the request to the control plane VCN 516 through the Internet gateway 534. The request can be received by the LB subnet(s) 522 contained in the control plane DMZ tier 520. The LB subnet(s) 522 may determine that the request is valid, and in response to this determination, the LB subnet(s) 522 can transmit the request to app subnet(s) 526 contained in the control plane app tier 524. If the request is validated and requires a call to public Internet 554, the call to public Internet 554 may be transmitted to the NAT gateway 538 that can make the call to public Internet 554. Metadata that may be desired to be stored by the request can be stored in the DB subnet(s) 530.

In some examples, the data plane mirror app tier 540 can facilitate direct communication between the control plane VCN 516 and the data plane VCN 518. For example, changes, updates, or other suitable modifications to configuration may be desired to be applied to the resources contained in the data plane VCN 518. Via a VNIC 542, the control plane VCN 516 can directly communicate with, and can thereby execute the changes, updates, or other suitable modifications to configuration to, resources contained in the data plane VCN 518.

In some embodiments, the control plane VCN 516 and the data plane VCN 518 can be contained in the cloud service tenancy 519. In this case, the user, or the customer, of the system may not own or operate either the control plane VCN 516 or the data plane VCN 518. Instead, the IaaS provider may own or operate the control plane VCN 516 and the data plane VCN 518, both of which may be contained in the cloud service tenancy 519. This embodiment can enable isolation of networks that may prevent users or customers from interacting with other users', or other customers', resources. Also, this embodiment may allow users or customers of the system to store databases privately without needing to rely on public Internet 554, which may not have a desired level of threat prevention, for storage.

In other embodiments, the LB subnet(s) 522 contained in the control plane VCN 516 can be configured to receive a signal from the cloud service gateway 536. In this embodiment, the control plane VCN 516 and the data plane VCN 518 may be configured to be called by a customer of the IaaS provider without calling public Internet 554. Customers of the IaaS provider may desire this embodiment since database(s) that the customers use may be controlled by the IaaS provider and may be stored on the cloud service tenancy 519, which may be isolated from public Internet 554.

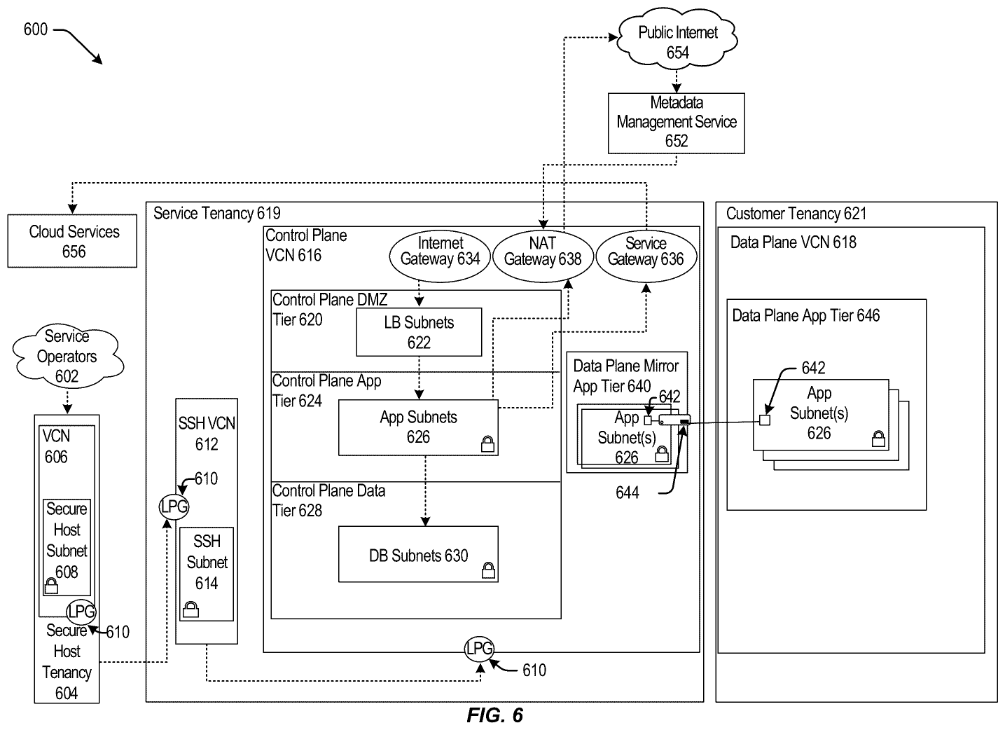

FIG. 6 is a block diagram 600 illustrating another example pattern of an IaaS architecture, according to at least one embodiment. Cloud service operators 602 (e.g., cloud service operators 502 of FIG. 5) can be communicatively coupled to a secure host tenancy 604 (e.g., the secure host tenancy 504 of FIG. 5) that can include a virtual cloud network (VCN) 606 (e.g., the VCN 506 of FIG. 5) and a secure host subnet 608 (e.g., the secure host subnet 508 of FIG. 5). The VCN 606 can include a local peering gateway (LPG) 610 (e.g., the LPG 510 of FIG. 5) that can be communicatively coupled to a secure shell (SSH) VCN 612 (e.g., the SSH VCN 512 of FIG. 5) via an LPG 510 contained in the SSH VCN 612. The SSH VCN 612 can include an SSH subnet 614 (e.g., the SSH subnet 514 of FIG. 5), and the SSH VCN 612 can be communicatively coupled to a control plane VCN 616 (e.g., the control plane VCN 516 of FIG. via an LPG 610 contained in the control plane VCN 616. The control plane VCN 616 can be contained in a cloud service tenancy 619 (e.g., the cloud service tenancy 519 of FIG. 5), and the data plane VCN 618 (e.g., the data plane VCN 518 of FIG. 5) can be contained in a customer tenancy 621 that may be owned or operated by users, or customers, of the system.

The control plane VCN 616 can include a control plane DMZ tier 620 (e.g., the control plane DMZ tier 520 of FIG. 5) that can include LB subnet(s) 622 (e.g., LB subnet(s) 522 of FIG. a control plane app tier 624 (e.g., the control plane app tier 524 of FIG. 5) that can include app subnet(s) 626 (e.g., app subnet(s) 526 of FIG. 5), a control plane data tier 628 (e.g., the control plane data tier 528 of FIG. 5) that can include database (DB) subnet(s) 630 (e.g., similar to DB subnet(s) 530 of FIG. 5). The LB subnet(s) 622 contained in the control plane DMZ tier 620 can be communicatively coupled to the app subnet(s) 626 contained in the control plane app tier 624 and an Internet gateway 634 (e.g., the Internet gateway 534 of FIG. 5) that can be contained in the control plane VCN 616, and the app subnet(s) 626 can be communicatively coupled to the DB subnet(s) 630 contained in the control plane data tier 628 and a cloud service gateway 636 (e.g., the cloud service gateway 536 of FIG. 5) and a network address translation (NAT) gateway 638 (e.g., the NAT gateway 538 of FIG. 5). The control plane VCN 616 can include the cloud service gateway 636 and the NAT gateway 638.

The control plane VCN 616 can include a data plane mirror app tier 640 (e.g., the data plane mirror app tier 540 of FIG. 5) that can include app subnet(s) 626. The app subnet(s) 626 contained in the data plane mirror app tier 640 can include a virtual network interface controller (VNIC) 642 (e.g., the VNIC of 542) that can execute a compute instance 644 (e.g., similar to the compute instance 544 of FIG. 5). The compute instance 644 can facilitate communication between the app subnet(s) 626 of the data plane mirror app tier 640 and the app subnet(s) 626 that can be contained in a data plane app tier 646 (e.g., the data plane app tier 546 of FIG. 5) via the VNIC 642 contained in the data plane mirror app tier 640 and the VNIC 642 contained in the data plane app tier 646.

The Internet gateway 634 contained in the control plane VCN 616 can be communicatively coupled to a metadata management cloud service 652 (e.g., the metadata management cloud service 552 of FIG. 5) that can be communicatively coupled to public Internet 654 (e.g., public Internet 554 of FIG. 5). Public Internet 654 can be communicatively coupled to the NAT gateway 638 contained in the control plane VCN 616. The cloud service gateway 636 contained in the control plane VCN 616 can be communicatively couple to cloud services 656 (e.g., cloud services 556 of FIG. 5).

In some examples, the data plane VCN 618 can be contained in the customer tenancy 621. In this case, the IaaS provider may provide the control plane VCN 616 for each customer, and the IaaS provider may, for each customer, set up a unique compute instance 644 that is contained in the cloud service tenancy 619. Each compute instance 644 may allow communication between the control plane VCN 616, contained in the cloud service tenancy 619, and the data plane VCN 618 that is contained in the customer tenancy 621. The compute instance 644 may allow resources, which are provisioned in the control plane VCN 616 that is contained in the cloud service tenancy 619, to be deployed or otherwise used in the data plane VCN 618 that is contained in the customer tenancy 621.

In other examples, the customer of the IaaS provider may have databases that live in the customer tenancy 621. In this example, the control plane VCN 616 can include the data plane mirror app tier 640 that can include app subnet(s) 626. The data plane mirror app tier 640 can reside in the data plane VCN 618, but the data plane mirror app tier 640 may not live in the data plane VCN 618. That is, the data plane mirror app tier 640 may have access to the customer tenancy 621, but the data plane mirror app tier 640 may not exist in the data plane VCN 618 or be owned or operated by the customer of the IaaS provider. The data plane mirror app tier 640 may be configured to make calls to the data plane VCN 618 but may not be configured to make calls to any entity contained in the control plane VCN 616. The customer may desire to deploy or otherwise use resources in the data plane VCN 618 that are provisioned in the control plane VCN 616, and the data plane mirror app tier 640 can facilitate the desired deployment, or other usage of resources, of the customer.

In some embodiments, the customer of the IaaS provider can apply filters to the data plane VCN 618. In this embodiment, the customer can determine what the data plane VCN 618 can access, and the customer may restrict access to public Internet 654 from the data plane VCN 618. The IaaS provider may not be able to apply filters or otherwise control access of the data plane VCN 618 to any outside networks or databases. Applying filters and controls by the customer onto the data plane VCN 618, contained in the customer tenancy 621, can help isolate the data plane VCN 618 from other customers and from public Internet 654.

In some embodiments, cloud services 656 can be called by the cloud service gateway 636 to access cloud services that may not exist on public Internet 654, on the control plane VCN 616, or on the data plane VCN 618. The connection between cloud services 656 and the control plane VCN 616 or the data plane VCN 618 may not be live or continuous. Cloud services 656 may exist on a different network owned or operated by the IaaS provider. Cloud services 656 may be configured to receive calls from the cloud service gateway 636 and may be configured to not receive calls from public Internet 654. Some cloud services 656 may be isolated from other cloud services 656, and the control plane VCN 616 may be isolated from cloud services 656 that may not be in the same region as the control plane VCN 616. For example, the control plane VCN 616 may be located in “Region 1,” and cloud service “Deployment 5,” may be located in Region 1 and in “Region 2.” If a call to Deployment 5 is made by the cloud service gateway 636 contained in the control plane VCN 616 located in Region 1, the call may be transmitted to Deployment 5 in Region 1. In this example, the control plane VCN 616, or Deployment 5 in Region 1, may not be communicatively coupled to, or otherwise in communication with, Deployment 5 in Region 2.

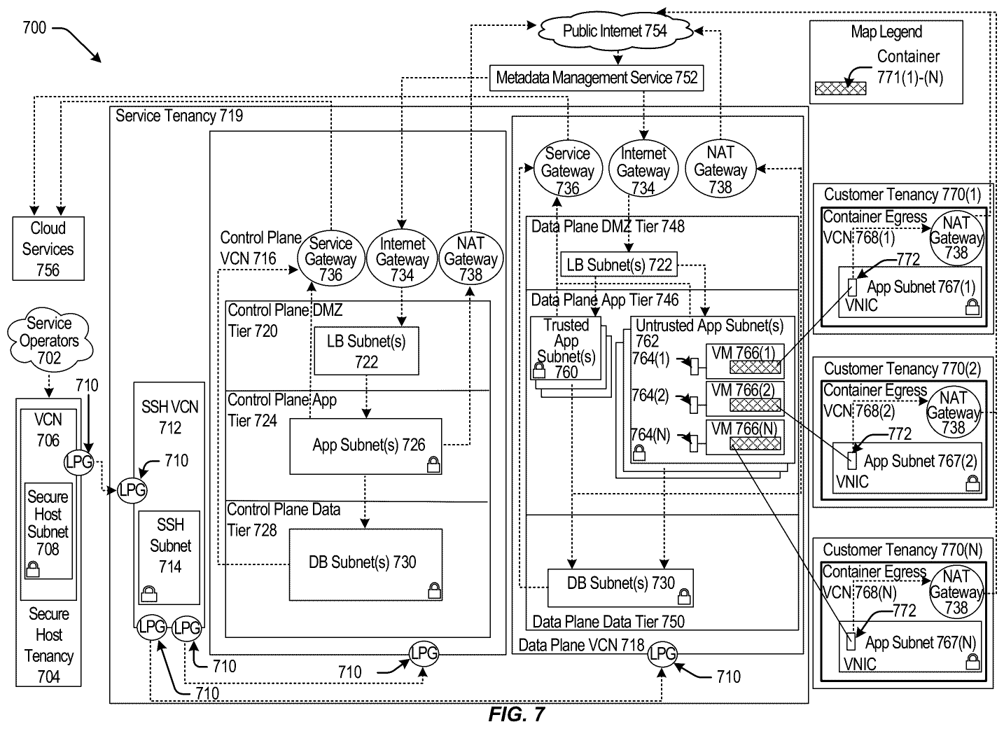

FIG. 7 is a block diagram 700 illustrating another example pattern of an IaaS architecture, according to at least one embodiment. Cloud service operators 702 (e.g., cloud service operators 502 of FIG. 5) can be communicatively coupled to a secure host tenancy 704 (e.g., the secure host tenancy 504 of FIG. 5) that can include a virtual cloud network (VCN) 706 (e.g., the VCN 506 of FIG. 5) and a secure host subnet 708 (e.g., the secure host subnet 508 of FIG. 5). The VCN 706 can include an LPG 710 (e.g., the LPG 510 of FIG. 5) that can be communicatively coupled to an SSH VCN 712 (e.g., the SSH VCN 512 of FIG. 5) via an LPG 710 contained in the SSH VCN 712. The SSH VCN 712 can include an SSH subnet 714 (e.g., the SSH subnet 514 of FIG. 5), and the SSH VCN 712 can be communicatively coupled to a control plane VCN 716 (e.g., the control plane VCN 516 of FIG. 5) via an LPG 710 contained in the control plane VCN 716 and to a data plane VCN 718 (e.g., the data plane VCN 518 of FIG. via an LPG 710 contained in the data plane VCN 718. The control plane VCN 716 and the data plane VCN 718 can be contained in a cloud service tenancy 719 (e.g., the cloud service tenancy 519 of FIG. 5).

The control plane VCN 716 can include a control plane DMZ tier 720 (e.g., the control plane DMZ tier 520 of FIG. 5) that can include load balancer (LB) subnet(s) 722 (e.g., LB subnet(s) 522 of FIG. 5), a control plane app tier 724 (e.g., the control plane app tier 524 of FIG. that can include app subnet(s) 726 (e.g., similar to app subnet(s) 526 of FIG. 5), a control plane data tier 728 (e.g., the control plane data tier 528 of FIG. 5) that can include DB subnet(s) 730. The LB subnet(s) 722 contained in the control plane DMZ tier 720 can be communicatively coupled to the app subnet(s) 726 contained in the control plane app tier 724 and to an Internet gateway 734 (e.g., the Internet gateway 534 of FIG. 5) that can be contained in the control plane VCN 716, and the app subnet(s) 726 can be communicatively coupled to the DB subnet(s) 730 contained in the control plane data tier 728 and to a cloud service gateway 736 (e.g., the cloud service gateway of FIG. 5) and a network address translation (NAT) gateway 738 (e.g., the NAT gateway 538 of FIG. 5). The control plane VCN 716 can include the cloud service gateway 736 and the NAT gateway 738.

The data plane VCN 718 can include a data plane app tier 746 (e.g., the data plane app tier 546 of FIG. 5), a data plane DMZ tier 748 (e.g., the data plane DMZ tier 548 of FIG. 5), and a data plane data tier 750 (e.g., the data plane data tier 550 of FIG. 5). The data plane DMZ tier 748 can include LB subnet(s) 722 that can be communicatively coupled to trusted app subnet(s) 760 and untrusted app subnet(s) 762 of the data plane app tier 746 and the Internet gateway 734 contained in the data plane VCN 718. The trusted app subnet(s) 760 can be communicatively coupled to the cloud service gateway 736 contained in the data plane VCN 718, the NAT gateway 738 contained in the data plane VCN 718, and DB subnet(s) 730 contained in the data plane data tier 750. The untrusted app subnet(s) 762 can be communicatively coupled to the cloud service gateway 736 contained in the data plane VCN 718 and DB subnet(s) 730 contained in the data plane data tier 750. The data plane data tier 750 can include DB subnet(s) 730 that can be communicatively coupled to the cloud service gateway 736 contained in the data plane VCN 718.

The untrusted app subnet(s) 762 can include one or more primary VNICs 764(1)-(N) that can be communicatively coupled to tenant virtual machines (VMs) 766(1)-(N). Each tenant VM 766(1)-(N) can be communicatively coupled to a respective app subnet 767(1)-(N) that can be contained in respective container egress VCNs 768(1)-(N) that can be contained in respective customer tenancies 770(1)-(N). Respective secondary VNICs 772(1)-(N) can facilitate communication between the untrusted app subnet(s) 762 contained in the data plane VCN 718 and the app subnet contained in the container egress VCNs 768(1)-(N). Each container egress VCNs 768(1)-(N) can include a NAT gateway 738 that can be communicatively coupled to public Internet 754 (e.g., public Internet 554 of FIG. 5).

The Internet gateway 734 contained in the control plane VCN 716 and contained in the data plane VCN 718 can be communicatively coupled to a metadata management cloud service 752 (e.g., the metadata management cloud service 552 of FIG. 5) that can be communicatively coupled to public Internet 754. Public Internet 754 can be communicatively coupled to the NAT gateway 738 contained in the control plane VCN 716 and contained in the data plane VCN 718. The cloud service gateway 736 contained in the control plane VCN 716 and contained in the data plane VCN 718 can be communicatively couple to cloud services 756.

In some embodiments, the data plane VCN 718 can be integrated with customer tenancies 770. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 746. Code to run the function may be executed in the VMs 766(1)-(N), and the code may not be configured to run anywhere else on the data plane VCN 718. Each VM 766(1)-(N) may be connected to one customer tenancy 770. Respective containers 771(1)-(N) contained in the VMs 766(1)-(N) may be configured to run the code. In this case, there can be a dual isolation (e.g., the containers 771(1)-(N) running code, where the containers 771(1)-(N) may be contained in at least the VM 766(1)-(N) that are contained in the untrusted app subnet(s) 762), which may help prevent incorrect or otherwise undesirable code from damaging the network of the IaaS provider or from damaging a network of a different customer. The containers 771(1)-(N) may be communicatively coupled to the customer tenancy 770 and may be configured to transmit or receive data from the customer tenancy 770. The containers 771(1)-(N) may not be configured to transmit or receive data from any other entity in the data plane VCN 718. Upon completion of running the code, the IaaS provider may kill or otherwise dispose of the containers 771(1)-(N).

In some embodiments, the trusted app subnet(s) 760 may run code that may be owned or operated by the IaaS provider. In this embodiment, the trusted app subnet(s) 760 may be communicatively coupled to the DB subnet(s) 730 and be configured to execute CRUD operations in the DB subnet(s) 730. The untrusted app subnet(s) 762 may be communicatively coupled to the DB subnet(s) 730, but in this embodiment, the untrusted app subnet(s) may be configured to execute read operations in the DB subnet(s) 730. The containers 771(1)-(N) that can be contained in the VM 766(1)-(N) of each customer and that may run code from the customer may not be communicatively coupled with the DB subnet(s) 730.

In other embodiments, the control plane VCN 716 and the data plane VCN 718 may not be directly communicatively coupled. In this embodiment, there may be no direct communication between the control plane VCN 716 and the data plane VCN 718. However, communication can occur indirectly through at least one method. An LPG 710 may be established by the IaaS provider that can facilitate communication between the control plane VCN 716 and the data plane VCN 718. In another example, the control plane VCN 716 or the data plane VCN 718 can make a call to cloud services 756 via the cloud service gateway 736. For example, a call to cloud services 756 from the control plane VCN 716 can include a request for a cloud service that can communicate with the data plane VCN 718.

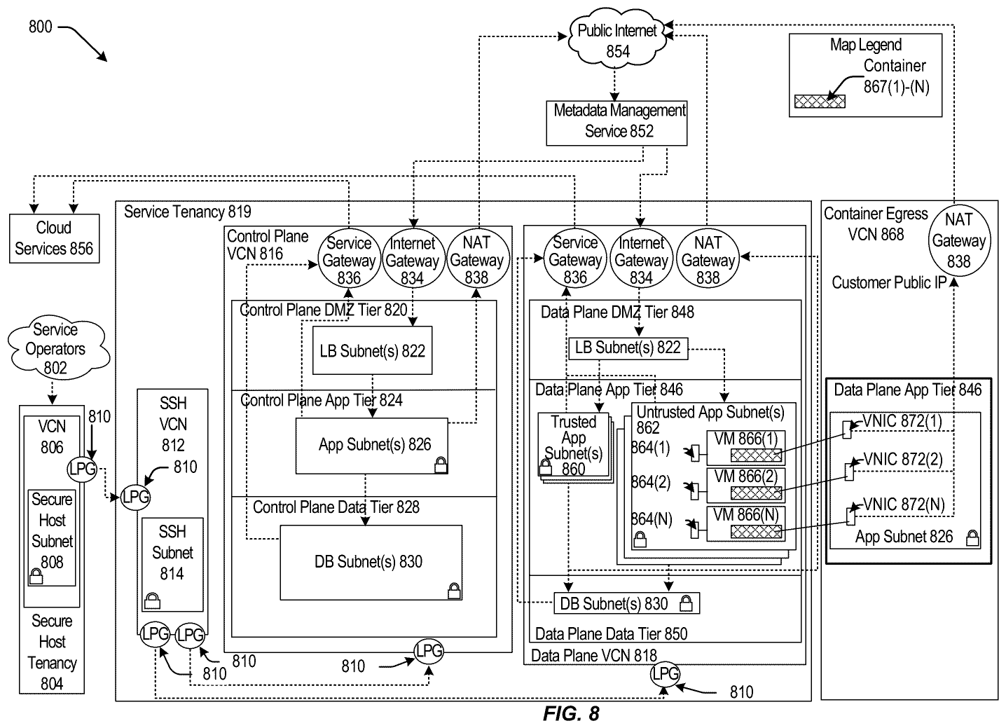

FIG. 8 is a block diagram 800 illustrating another example pattern of an IaaS architecture, according to at least one embodiment. Cloud service operators 802 (e.g., cloud service operators 502 of FIG. 5) can be communicatively coupled to a secure host tenancy 804 (e.g., the secure host tenancy 504 of FIG. 5) that can include a virtual cloud network (VCN) 806 (e.g., the VCN 506 of FIG. 5) and a secure host subnet 808 (e.g., the secure host subnet 508 of FIG. 5). The VCN 806 can include an LPG 810 (e.g., the LPG 510 of FIG. 5) that can be communicatively coupled to an SSH VCN 812 (e.g., the SSH VCN 512 of FIG. 5) via an LPG 810 contained in the SSH VCN 812. The SSH VCN 812 can include an SSH subnet 814 (e.g., the SSH subnet 514 of FIG. 5), and the SSH VCN 812 can be communicatively coupled to a control plane VCN 816 (e.g., the control plane VCN 516 of FIG. 5) via an LPG 810 contained in the control plane VCN 816 and to a data plane VCN 818 (e.g., the data plane VCN 518 of FIG. 5) via an LPG 810 contained in the data plane VCN 818. The control plane VCN 816 and the data plane VCN 818 can be contained in a cloud service tenancy 819 (e.g., the cloud service tenancy 519 of FIG. 5).

The control plane VCN 816 can include a control plane DMZ tier 820 (e.g., the control plane DMZ tier 520 of FIG. 5) that can include LB subnet(s) 822 (e.g., LB subnet(s) 522 of FIG. 5), a control plane app tier 824 (e.g., the control plane app tier 524 of FIG. 5) that can include app subnet(s) 826 (e.g., app subnet(s) 526 of FIG. 5), a control plane data tier 828 (e.g., the control plane data tier 528 of FIG. 5) that can include DB subnet(s) 830 (e.g., DB subnet(s) 730 of FIG. 7). The LB subnet(s) 822 contained in the control plane DMZ tier 820 can be communicatively coupled to the app subnet(s) 826 contained in the control plane app tier 824 and to an Internet gateway 834 (e.g., the Internet gateway 534 of FIG. 5) that can be contained in the control plane VCN 816, and the app subnet(s) 826 can be communicatively coupled to the DB subnet(s) 830 contained in the control plane data tier 828 and to a cloud service gateway 836 (e.g., the cloud service gateway of FIG. 5) and a network address translation (NAT) gateway 838 (e.g., the NAT gateway 538 of FIG. 5). The control plane VCN 816 can include the cloud service gateway 836 and the NAT gateway 838.

The data plane VCN 818 can include a data plane app tier 846 (e.g., the data plane app tier 546 of FIG. 5), a data plane DMZ tier 848 (e.g., the data plane DMZ tier 548 of FIG. 5), and a data plane data tier 850 (e.g., the data plane data tier 550 of FIG. 5). The data plane DMZ tier 848 can include LB subnet(s) 822 that can be communicatively coupled to trusted app subnet(s) 860 (e.g., trusted app subnet(s) 760 of FIG. 7) and untrusted app subnet(s) 862 (e.g., untrusted app subnet(s) 762 of FIG. 7) of the data plane app tier 846 and the Internet gateway 834 contained in the data plane VCN 818. The trusted app subnet(s) 860 can be communicatively coupled to the cloud service gateway 836 contained in the data plane VCN 818, the NAT gateway 838 contained in the data plane VCN 818, and DB subnet(s) 830 contained in the data plane data tier 850. The untrusted app subnet(s) 862 can be communicatively coupled to the cloud service gateway 836 contained in the data plane VCN 818 and DB subnet(s) 830 contained in the data plane data tier 850. The data plane data tier 850 can include DB subnet(s) 830 that can be communicatively coupled to the cloud service gateway 836 contained in the data plane VCN 818.

The untrusted app subnet(s) 862 can include primary VNICs 864(1)-(N) that can be communicatively coupled to tenant virtual machines (VMs) 866(1)-(N) residing within the untrusted app subnet(s) 862. Each tenant VM 866(1)-(N) can run code in a respective container 867(1)-(N), and be communicatively coupled to an app subnet 826 that can be contained in a data plane app tier 846 that can be contained in a container egress VCN 868. Respective secondary VNICs 872(1)-(N) can facilitate communication between the untrusted app subnet(s) 862 contained in the data plane VCN 818 and the app subnet contained in the container egress VCN 868. The container egress VCN can include a NAT gateway 838 that can be communicatively coupled to public Internet 854 (e.g., public Internet 554 of FIG. 5).

The Internet gateway 834 contained in the control plane VCN 816 and contained in the data plane VCN 818 can be communicatively coupled to a metadata management cloud service 852 (e.g., the metadata management cloud service 552 of FIG. 5) that can be communicatively coupled to public Internet 854. Public Internet 854 can be communicatively coupled to the NAT gateway 838 contained in the control plane VCN 816 and contained in the data plane VCN 818. The cloud service gateway 836 contained in the control plane VCN 816 and contained in the data plane VCN 818 can be communicatively couple to cloud services 856.

In some examples, the pattern illustrated by the architecture of block diagram 800 of FIG. 8 may be considered an exception to the pattern illustrated by the architecture of block diagram 700 of FIG. 7 and may be desirable for a customer of the IaaS provider if the IaaS provider cannot directly communicate with the customer (e.g., a disconnected region). The respective containers 867(1)-(N) that are contained in the VMs 866(1)-(N) for each customer can be accessed in real-time by the customer. The containers 867(1)-(N) may be configured to make calls to respective secondary VNICs 872(1)-(N) contained in app subnet(s) 826 of the data plane app tier 846 that can be contained in the container egress VCN 868. The secondary VNICs 872(1)-(N) can transmit the calls to the NAT gateway 838 that may transmit the calls to public Internet 854. In this example, the containers 867(1)-(N) that can be accessed in real-time by the customer can be isolated from the control plane VCN 816 and can be isolated from other entities contained in the data plane VCN 818. The containers 867(1)-(N) may also be isolated from resources from other customers.

In other examples, the customer can use the containers 867(1)-(N) to call cloud services 856. In this example, the customer may run code in the containers 867(1)-(N) that requests a cloud service from cloud services 856. The containers 867(1)-(N) can transmit this request to the secondary VNICs 872(1)-(N) that can transmit the request to the NAT gateway that can transmit the request to public Internet 854. Public Internet 854 can transmit the request to LB subnet(s) 822 contained in the control plane VCN 816 via the Internet gateway 834. In response to determining the request is valid, the LB subnet(s) can transmit the request to app subnet(s) 826 that can transmit the request to cloud services 856 via the cloud service gateway 836.

It should be appreciated that IaaS architectures depicted in the figures as block diagrams 500, 600, 700, 800 may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database cloud service offerings that are delivered to a customer in a self-cloud service, subscription-based, elastically scalable, reliable, highly available, and secure manner. An example of such an IaaS system is the Oracle Cloud Infrastructure (OCI) provided by the present assignee.

FIG. 9 illustrates an example computer system 900, in which various embodiments may be implemented. The system 900 may be used to implement any of the computer systems described above. As shown in the figure, computer system 900 includes a processing unit 904 that communicates with a number of peripheral subsystems via a bus subsystem 902. These peripheral subsystems may include a processing acceleration unit 906, an I/O subsystem 908, a storage subsystem 918 and a communications subsystem 924. Storage subsystem 918 includes tangible computer-readable storage media 922 and a system memory 910.

Bus subsystem 902 provides a mechanism for letting the various components and subsystems of computer system 900 communicate with each other as intended. Although bus subsystem 902 is shown schematically as a single bus, alternative embodiments of the bus subsystem may utilize multiple buses. Bus subsystem 902 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 904, which can be implemented as one or more integrated circuits (e.g., a conventional microprocessor or microcontroller), controls the operation of computer system 900. One or more processors may be included in processing unit 904. These processors may include single core or multicore processors. In certain embodiments, processing unit 904 may be implemented as one or more independent processing units 932 and/or 934 with single or multicore processors included in each processing unit. In other embodiments, processing unit 904 may also be implemented as a quad-core processing unit formed by integrating two dual-core processors into a single chip.

In various embodiments, processing unit 904 can execute a variety of programs in response to program code and can maintain multiple concurrently executing programs or processes. At any given time, some or all of the program code to be executed can be resident in processing unit(s) 904 and/or in storage subsystem 918. Through suitable programming, processing unit(s) 904 can provide various functionalities described above. Computer system 900 may additionally include a processing acceleration unit 906, which can include a digital signal processor (DSP), a special-purpose processor, and/or the like.

I/O subsystem 908 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Sirig navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments, and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 900 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 900 may comprise a storage subsystem 918 that provides a tangible non-transitory computer-readable storage medium for storing software and data constructs that provide the functionality of the embodiments described in this disclosure. The software can include programs, code, instructions, scripts, etc., that when executed by one or more cores or processors of processing unit 904 provide the functionality described above. Storage subsystem 918 may also provide a repository for storing data used in accordance with the present disclosure.

As depicted in the example in FIG. 9, storage subsystem 918 can include various components including a system memory 910, computer-readable storage media 922, and a computer readable storage media reader 920. System memory 910 may store program instructions that are loadable and executable by processing unit 904. System memory 910 may also store data that is used during the execution of the instructions and/or data that is generated during the execution of the program instructions. Various different kinds of programs may be loaded into system memory 910 including but not limited to client applications, Web browsers, mid-tier applications, relational database management systems (RDBMS), virtual machines, containers, etc.

System memory 910 may also store an operating system 916. Examples of operating system 916 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 900 executes one or more virtual machines, the virtual machines along with their guest operating systems (GOSs) may be loaded into system memory 910 and executed by one or more processors or cores of processing unit 904.

System memory 910 can come in different configurations depending upon the type of computer system 900. For example, system memory 910 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 910 may include a basic input/output system (BIOS) containing basic routines that help to transfer information between elements within computer system 900, such as during start-up.

Computer-readable storage media 922 may represent remote, local, fixed, and/or removable storage devices plus storage media for temporarily and/or more permanently containing, storing, computer-readable information for use by computer system 900 including instructions executable by processing unit 904 of computer system 900.

Computer-readable storage media 922 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 922 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 922 may include, but is not limited to, Zip® drives, flash memory cards, universal serial bus (USB) flash drives, secure digital (SD) cards, DVD disks, digital video tape, and the like. Computer-readable storage media 922 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 900.

Machine-readable instructions executable by one or more processors or cores of processing unit 904 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 924 provides an interface to other computer systems and networks. Communications subsystem 924 serves as an interface for receiving data from and transmitting data to other systems from computer system 900. For example, communications subsystem 924 may enable computer system 900 to connect to one or more devices via the Internet. In some embodiments communications subsystem 924 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 924 can provide wired network connectivity (e.g., Ethernet) in addition to or instead of a wireless interface.

In some embodiments, communications subsystem 924 may also receive input communication in the form of structured and/or unstructured data feeds 926, event streams 928, event updates 930, and the like on behalf of one or more users who may use computer system 900.

By way of example, communications subsystem 924 may be configured to receive data feeds 926 in real-time from users of social networks and/or other communication cloud services such as Twitter® feeds, Facebook® updates, web feeds such as Rich Site Summary (RSS) feeds, and/or real-time updates from one or more third party information sources.

Additionally, communications subsystem 924 may also be configured to receive data in the form of continuous data streams, which may include event streams 928 of real-time events and/or event updates 930, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 924 may also be configured to output the structured and/or unstructured data feeds 926, event streams 928, event updates 930, and the like to one or more databases that may be in communication with one or more streaming data source computers coupled to computer system 900.

Computer system 900 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 900 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments, and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A method comprising:
displaying, via a user interface (UI) associated with a code editor, a plurality of cloud services, the plurality of cloud services including a first cloud service and a second cloud service;
receiving, by the code editor, a first signal indicating selection, via the UI, of a first cloud service from the plurality of cloud services;
displaying, in the UI, a first edit area, the first edit area displaying contents of a first artifact associated with the first cloud service and enabling editing of the contents of the first artifact;
receiving, by the code editor, a second signal indicating selection, via the UI, of a second cloud service from the plurality of cloud services, wherein the second cloud service is different from the first cloud service; and
displaying, in the UI, a second edit area, the second edit area displaying contents of a second artifact associated with the second cloud service and enabling editing of the contents of the second artifact.

2. The method of claim 1, wherein the first cloud service is provided by a first cloud service provider and the second cloud service is provided by a second cloud service provider that is different from the first cloud services provider.

3. The method of claim 1, wherein the first cloud service and the second cloud service are provided by the same cloud service provider.

4. The method of claim 1, wherein the code editor is executed by a first system and the UI is displayed on a different system.

5. The method of claim 1 further comprising:
responsive to receiving the first signal, establishing, by the code editor, a connection with a first infrastructure associated with the first cloud service;
obtaining, by the code editor, information related to a first set of one or more artifacts associated with the first cloud service, the first set of one or more artifacts including the first artifact; and
displaying, by the code editor and on the UI, information identifying the first set of one or more artifacts.

6. The method of claim 5 wherein establishing the connection with the first infrastructure associated with the first cloud service comprises using, by the code editor, a first plugin for the first cloud service to connect to the first infrastructure.

7. The method of claim 5 further comprising:
receiving, by the code editor, a third signal indicating selection, via the UI, of the first artifact from the first set of one or more artifacts; and
obtaining, by the code editor, the first artifact from the first infrastructure associated with the first cloud service; and
wherein displaying the first edit area comprises causing, by the code editor, the contents of the first artifact to be displayed in the first edit area.

8. The method of claim 1 further comprising:
responsive to receiving the first signal, establishing, by the code editor, a connection with a first infrastructure associated with the first cloud service;
obtaining, by the code editor, information related to a first set of one or more artifacts associated with the first cloud service, the first set of one or more artifacts including the first artifact; and
displaying, by the code editor and on the UI, information identifying the first set of one or more artifacts;
responsive to receiving the second signal, establishing, by the code editor, a connection with a second infrastructure associated with the second cloud service;
obtaining, by the code editor, information related to a second set of one or more artifacts associated with the second cloud service, the second set of one or more artifacts including the second artifact;
displaying, by the code editor and on the UI, information identifying the second set of one or more artifacts;
receiving, by the code editor, a fourth signal indicating selection, via the UI, of the second artifact from the second set of one or more artifacts;
obtaining, by the code editor, the second artifact from the second infrastructure associated with the second cloud service; and
wherein displaying the second edit area comprises causing, by the code editor, the contents of the second artifact to be displayed in the second edit area.

9. The method of claim 1 further comprising:
receiving, via the first edit area, one or more edits to the first artifact to generate edited contents for the first artifact;
receiving, by the code editor, a signal to save the edited contents of the first artifact; and
responsive to receiving the signal to save the edited contents of the first artifact, causing, by the code editor, the edited contents of the first artifact to be stored in a repository associated with the first cloud service.

10. The method of claim 1 wherein the code editor is part of a cloud integrated development environment (IDE).

11. The method of claim 10 wherein the IDE includes one or more of: a file explorer, a debugger, a compiler, or a source control component.

12. The method of claim 1 wherein displaying the second edit area comprises displaying the second edit and the first edit area simultaneously.

13. The method of claim 1 wherein displaying the second edit area comprises:
causing the contents of the second artifact to be displayed in the UI; and
causing the contents of the first artifact to be removed from being displayed by the UI.

14. The method of claim 1 wherein the first artifact is a file containing code, a script file, or a configuration information file.

15. The method of claim 1 wherein the first artifact is an editable file used for enabling, provisioning, or deploying the first cloud service.

16. A system comprising:
a memory storing a set of instructions;
a set of one or more processors configured to execute the set of instructions to perform processing comprising:
displaying, via a user interface (UI) associated with a code editor, a plurality of cloud services, the plurality of cloud services including a first cloud service and a second cloud service;
receiving, by the code editor, a first signal indicating selection, via the UI, of a first cloud service from the plurality of cloud services;
displaying, in the UI, a first edit area, the first edit area displaying contents of a first artifact associated with the first cloud service and enabling editing of the contents of the first artifact;
receiving, by the code editor, a second signal indicating selection, via the UI, of a second cloud service from the plurality of cloud services, wherein the second cloud service is different from the first cloud service; and
displaying, in the UI, a second edit area, the second edit area displaying contents of a second artifact associated with the second cloud service and enabling editing of the contents of the second artifact.

17. The system of claim 16 wherein the processing further comprises:
responsive to receiving the first signal, establishing, by the code editor, a connection with a first infrastructure associated with the first cloud service;
obtaining, by the code editor, information related to a first set of one or more artifacts associated with the first cloud service, the first set of one or more artifacts including the first artifact; and
displaying, by the code editor and on the UI, information identifying the first set of one or more artifacts;
responsive to receiving the second signal, establishing, by the code editor, a connection with a second infrastructure associated with the second cloud service;
obtaining, by the code editor, information related to a second set of one or more artifacts associated with the second cloud service, the second set of one or more artifacts including the first artifact; and
displaying, by the code editor and on the UI, information identifying the second set of one or more artifacts.

18. The system of claim 17 wherein the processing further comprises:
receiving, by the code editor, a third signal indicating selection, via the UI, of the first artifact from the first set of one or more artifacts; and
obtaining, by the code editor, the first artifact from the first infrastructure associated with the first cloud service; and
wherein displaying the first edit area comprises causing, by the code editor, the contents of the first artifact to be displayed in the first edit area.

19. A non-transitory computer-readable medium storing instructions executable by one or more processors for causing the one or more processors to perform operations comprising:
displaying, via a user interface (UI) associated with a code editor, a plurality of cloud services, the plurality of cloud services including a first cloud service and a second cloud service;
receiving, by the code editor, a first signal indicating selection, via the UI, of a first cloud service from the plurality of cloud services;
displaying, in the UI, a first edit area, the first edit area displaying contents of a first artifact associated with the first cloud service and enabling editing of the contents of the first artifact;
receiving, by the code editor, a second signal indicating selection, via the UI, of a second cloud service from the plurality of cloud services, wherein the second cloud service is different from the first cloud service; and
displaying, in the UI, a second edit area, the second edit area displaying contents of a second artifact associated with the second cloud service and enabling editing of the contents of the second artifact.

20. The non-transitory computer-readable medium of claim 19 wherein the operations further comprise:
responsive to receiving the first signal, establishing, by the code editor, a connection with a first infrastructure associated with the first cloud service;
obtaining, by the code editor, information related to a first set of one or more artifacts associated with the first cloud service, the first set of one or more artifacts including the first artifact;
displaying, by the code editor and on the UI, information identifying the first set of one or more artifacts;
receiving, by the code editor, a third signal indicating selection, via the UI, of the first artifact from the first set of one or more artifacts;
obtaining, by the code editor, the first artifact from the first infrastructure associated with the first cloud service;
receiving, via the first edit area, one or more edits to the first artifact to generate edited contents for the first artifact;
receiving, by the code editor and via the UI, a signal to save the edited contents of the first artifact; and
responsive to receiving the signal to save the edited contents of the first artifact, causing, by the code editor, the edited contents of the first artifact to be stored in a repository associated with the first cloud service.
